(19) United States
(12) Patent Application Publication
(10) Pub. No.: US 2014/0359757 A1
(43) Pub. Date: Dec. 4, 2014

(54) USER AUTHENTICATION BIOMETRICS IN MOBILE DEVICES

(71) Applicant: QUALCOMM Incorporated, San Diego, CA (US)

(72) Inventors: Muhammed Ibrahim Sezan, Los Gatos, CA (US); David C. Bartnik, Elma, NY (US); David William Burns, San Jose, CA (US); Jack Conway Kitchens, II, Buffalo, NY (US); Leonard C. Pratt, Lockport, NY (US); John Keith Schneider, Williamsville, NY (US); Suryaprakash Ganti, Los Altos, CA (US); Yair Karmi, San Diego, CA (US)

(73) Assignee: QUALCOMM Incorporated, San Diego, CA (US)

(21) Appl. No.: 14/178,156

(22) Filed: Feb. 11, 2014

Related U.S. Application Data
(63) Continuation-in-part of application No. 14/071,320, filed on Nov. 4, 2013.
(60) Provisional application No. 61/900,851, filed on Nov. 6, 2013.
(60) Provisional application No. 61/830,582, filed on Jun. 3, 2013.

(51) Int. Cl. G06F 21/32

(52) U.S. Cl. CPC G06F 21/32
USPC 726/19

(57) ABSTRACT

An authentication process may involve presenting an image on a display device, such as an icon associated with an application, indicating an area for a user to touch. At least partial fingerprint data may be obtained during one or more finger taps or touches in the area. Based on a comparison of the partial fingerprint data and master fingerprint data of the rightful user, a control system may determine whether to invoke a function. Invoking the function may involve authorizing a commercial transaction or unlocking the display device. In some implementations, determining whether to invoke the function may be based on a level of security.

### PRIORITY CLAIMS

This application claims priority to U.S. Provisional Application No. 61/900,851, filed on Nov. 6, 2013 and entitled “USER AUTHENTICATION BIOMETRICS IN MOBILE DEVICES,” which is hereby incorporated by reference. This application also claims priority to U.S. Provisional Application No. 61/830,582, filed on Jun. 3, 2013 and entitled “DISPLAY WITH PERIPHERALLY CONFIGURED ULTRASONIC BIOMETRIC SENSOR,” which is hereby incorporated by reference. This application also claims priority to U.S. application Ser. No. 14/071,320, filed on Nov. 4, 2013 and entitled “PIEZOELECTRIC FORCE SENSING ARRAY,” which is hereby incorporated by reference.

### TECHNICAL FIELD

This disclosure relates generally to authentication devices and methods, particularly authentication devices and methods applicable to mobile devices.

### DESCRIPTION OF THE RELATED TECHNOLOGY

As mobile devices become more versatile, user authentication becomes increasingly important. Increasing amounts of personal information may be stored on and/or accessible by a mobile device. Moreover, mobile devices are increasingly being used to make purchases and perform other commercial transactions. Existing authentication methods typically involve the use of a password or passcode, which may be forgotten by a rightful user or used by an unauthorized person. Improved authentication methods would be desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method that involves presenting an image on a display device indicating an area for a user to touch and obtaining partial fingerprint data from at least a partial finger touch in the area. The finger touch may, for example, involve left-thumb-side touching, right-thumb-side touching, or fingertip touching. The partial fingerprint data may correspond to a touching portion of a finger or a thumb. The method may involve comparing the partial fingerprint data with master fingerprint data of a rightful user and determining, based at least in part on the comparing process, whether to invoke a function. Invoking the function may involve authorizing a transaction, starting a personalized application or unlocking the display device. In some examples, the determination of whether to invoke the function may involve determining whether to authorize a transaction based on a level of security.

In some implementations, the partial fingerprint data may include known fingerprint data of the current master fingerprint data and new fingerprint data. The method may involve updating the master fingerprint data to include the new fingerprint data. The updating process may involve augmenting the master fingerprint data and/or adapting the master fingerprint data.

The method may involve determining finger tap characteristic data of the rightful user. Determining whether to invoke the function may be based, at least in part, on comparing finger tap characteristic data of a current user with finger tap characteristic data of the rightful user. In some implementations, the finger tap characteristic may correspond with a number of taps, a frequency of taps, a sequence of taps and/or an auditory signature.

The process of obtaining partial fingerprint data may involve an ultrasonic imaging process. In some such implementations, the process of obtaining partial fingerprint data may involve obtaining the partial fingerprint data via an ultrasonic sensor array while maintaining an ultrasonic transmitter in an “off” state.

In some implementations, the method may involve receiving device movement data. The determining process may be based, at least in part, on the device movement data.

The indicated area for the user to touch may differ according to the implementation. In some examples, the area for the user to touch may be within a display area, outside the display area or on a back of the display device. In some implementations, the area for the user to touch may overlap at least a portion of a fingerprint acquisition system.

In some implementations, the method may involve prompting the user to provide substantially complete fingerprint data for at least one finger. The method may involve associating the substantially complete fingerprint data with the rightful user and storing the substantially complete fingerprint data in a memory.

In some examples, the method may involve presenting one or more purchasing icons on the display device. The purchasing icons may, for example, correspond to purchasable items. The method may involve moving a representation of one of the purchasing icons onto the indicated area in response to a corresponding dragging movement of the touching portion of the finger or thumb. The method may involve determining whether to authorize a transaction.

In some implementations, the method may involve presenting one or more application icons on the display device. Each of the application icons may correspond to a software application. The method may involve moving a representation of one of the application icons onto the indicated area in response to a corresponding dragging movement of the touching portion of the finger or thumb. The method may involve determining whether to start the corresponding application.

Other innovative aspects of the subject matter described in this disclosure can be implemented in a method that involves presenting an image on a display device indicating an area for a user to touch in order to make a commercial transaction. The method may involve determining a level of security may correspond to the commercial transaction. The method also may involve obtaining partial fingerprint data from at least a partial finger touch in the area. The partial fingerprint data may correspond to a touching portion of a finger or a thumb. The method also may involve comparing the partial fingerprint data with master fingerprint data of a rightful user and determining, based at least in part on the comparing process and the level of security, whether to authorize the commercial transaction.

The level of security may be based on one or more of a requested payment amount, an amount of available credit, an amount of money to be transferred between accounts, a type of merchandise or the user's credit score. In some examples, the method may involve determining that the level of security indicates that additional data will be required in order to determine whether to authorize the commercial transaction. The additional data may include full fingerprint data for at least one finger, a finger tap characteristic and/or device movement data. The finger tap characteristic may correspond with a number of taps, a frequency of taps, a sequence of taps and/or an auditory signature.

Some or all of the methods described herein may be performed by one or more devices according to instructions (e.g., software) stored on non-transitory media. Such non-transitory media may include memory devices such as those described herein, including but not limited to random access memory (RAM) devices, read-only memory (ROM) devices, etc. Accordingly, other innovative aspects of the subject matter described in this disclosure can be implemented in a non-transitory medium having software stored thereon. For example, the software may include instructions for controlling at least one apparatus to present an image indicating an area for a user to touch and obtain partial fingerprint data from at least a partial finger touch in the area. The partial fingerprint data may correspond to a touching portion of a finger or a thumb. the software may include instructions for controlling at least one apparatus to compare the partial fingerprint data with master fingerprint data of a rightful user and to determine, based at least in part on the comparing process, whether to invoke a function.

The function may involve authorizing a transaction, starting a personalized application, or unlocking the display device. The partial fingerprint data may include known fingerprint data of the current master fingerprint data and new fingerprint data. The software may include instructions for controlling at least one apparatus to update the master fingerprint data to include the new fingerprint data. The updating may involve at least one of augmenting the master fingerprint data or adapting the master fingerprint data. The obtaining may involve an ultrasonic imaging process.

The software may include instructions for controlling at least one apparatus to present one or more purchasing icons on the display device. The purchasing icons may correspond to purchasable items. The software may include instructions for controlling at least one apparatus to move a representation of one of the purchasing icons onto the indicated area in response to a corresponding dragging movement of the touching portion of the finger or thumb and to determine whether to authorize a transaction.

In some examples, the software may include instructions for controlling at least one apparatus to present one or more application icons on the display device. Each of the application icons may correspond to a software application. The software may include instructions for controlling at least one apparatus to move a representation of one of the application icons onto the indicated area in response to a corresponding dragging movement of the touching portion of the finger or thumb and to determine whether to start the corresponding application.

Other innovative aspects of the subject matter described in this disclosure can be implemented in an apparatus that may include a display, a fingerprint acquisition system and a control system. The control system may be capable of controlling the display to present an image indicating an area for a user to touch; controlling the fingerprint acquisition system to obtain partial fingerprint data from at least a partial finger touch in the area, the partial fingerprint data may correspond to a touching portion of a finger or a thumb; comparing the partial fingerprint data with master fingerprint data of a rightful user; and determining, based at least in part on the comparing process, whether to invoke a function.

The apparatus may include a motion sensor system capable of sensing device movement and providing device movement data to the control system. The control system may be capable of determining whether the device movement data corresponds with device movement data of the rightful user.

In some implementations, the apparatus may include a finger tap sensing system. The control system may be capable of receiving, from the finger tap sensing system, information regarding one or more finger taps and of determining a finger tap characteristic data based on the information regarding one or more finger taps. Determining whether to invoke the function may be based, at least in part, on comparing the finger tap characteristic data with finger tap characteristic data of the rightful user. The finger tap characteristic data may correspond with a number of taps, a frequency of taps, a sequence of taps and/or an auditory signature.

In some examples, the fingerprint acquisition system may include an ultrasonic imaging system. According to some such implementations, the ultrasonic imaging system may include an ultrasonic sensor array and an ultrasonic transmitter. In some examples, the obtaining process may involve obtaining the partial fingerprint data via the ultrasonic sensor array while maintaining the ultrasonic transmitter in an “off” state. In some implementations, the fingerprint acquisition system may be positioned within a display area. However, in alternative implementations the fingerprint acquisition system may be positioned, at least in part, outside the display area. For example, the fingerprint acquisition system may be positioned on the periphery of the display area, on a side of the apparatus, on the back of the apparatus, etc.

Other innovative aspects of the subject matter described in this disclosure can be implemented in a method that may involve presenting an image on a display device indicating an area for a user to touch. The image may correspond to an icon associated with a first software application. The method may involve obtaining partial fingerprint data from at least a partial finger touch in the area. The partial fingerprint data may correspond to a touching portion of a finger or a thumb.

The method may involve comparing the partial fingerprint data with master fingerprint data of a rightful user. The master fingerprint data may, for example, correspond to a second software application relating to authentication functionality. The method may involve determining, based at least in part on the comparing process, whether to update the master fingerprint data to include the new fingerprint data. In some examples, the first software application does not relate to authentication functionality. In some implementations, the updating may involve augmenting the master fingerprint data and/or adapting the master fingerprint data.

The method may involve obtaining new finger tap characteristic data of the rightful user. The determining process may involve determining whether to update existing finger tap characteristic data of the rightful user according to the new finger tap characteristic data. In some examples, the finger tap characteristic may correspond with a number of taps, a frequency of taps, a sequence of taps and/or an auditory signature.

In some implementations, the method may involve receiving new device movement data of the rightful user. The determining process may involve determining whether to update existing device movement data of the rightful user according to the new device movement data.

Still other innovative aspects of the subject matter described in this disclosure can be implemented in a method that may involve presenting one or more icons on a display device to a user and receiving an indication that a digit of the user is touching an area of the display device may correspond to one of the presented icons. The method may involve moving a representation of one of the presented icons onto an area indicating a selection of the icon, in response to a corresponding dragging movement of the digit, acquiring biometric information from the digit when the digit is positioned in a fingerprinting sensing area and invoking a function based on the acquired biometric information.

The acquiring process may involve obtaining partial fingerprint data from the digit. Invoking the function may involve authorizing a transaction, starting an application or unlocking the display device.

Yet other innovative aspects of the subject matter described in this disclosure can be implemented in a method that may involve presenting an image on a display device indicating an area for a user to touch and obtaining partial fingerprint data from at least a partial finger touch in the area. The partial fingerprint data may correspond to a touching portion of a finger or a thumb. The method may involve performing an authentication process based, at least in part, on the partial fingerprint data.

In some implementations, the method may involve determining, based at least in part on the authentication process, whether to invoke a function. For example, invoking the function may involve authorizing a transaction, starting a personalized application, or unlocking the display device.

Further innovative aspects of the subject matter described in this disclosure can be implemented in a method that may involve presenting one or more icons on a display and receiving an indication that a user is interacting with at least one of the icons presented. The method may involve acquiring biometric information from a digit, during the user interaction with the icon, when the digit is positioned in a fingerprinting sensing area. The method may involve invoking a function based, at least in part, on the acquired biometric information.

In some examples, the acquiring process may involve obtaining partial fingerprint data from the digit. Receiving the indication that the user is interacting with an icon may involve receiving an indication that the digit is touching an area of the display device that corresponds to one of the presented icons. Alternatively, or additionally, receiving the indication may involve receiving an indication of a dragging motion of the digit towards an indicated area. The indicated area may, for example, be displayed on the display. However, in some examples the indicated area may be an edge of the display, a side of a display device or a back of the display device. For example, the display may be on a front side of the display device and the fingerprint sensing area may be on a side of the display device, on the back of the display device, etc.

In some implementations, receiving the indication that the user is interacting with an icon presented may involve receiving an indication that the user has tapped on the icon a number of times and/or within a range of time intervals. In some examples, acquiring the biometric information may involve an ultrasonic imaging process.

Other innovative aspects of the subject matter described in this disclosure can be implemented in an apparatus that may include a display, a fingerprint acquisition system and a control system. The control system may be capable of controlling the display to present an image indicating an area for a user to touch in order to make a commercial transaction, of determining a level of security may correspond to the commercial transaction and of obtaining, via the fingerprint acquisition system, partial fingerprint data from at least a partial finger touch in the area. The partial fingerprint data may correspond to a touching portion of a finger or a thumb. The control system may be capable of comparing the partial fingerprint data with master fingerprint data of a rightful user and of determining, based at least in part on the comparing process and the level of security, whether to authorize the commercial transaction.

In some examples, the level of security may be based on one or more of a requested payment amount, an amount of available credit, an amount of money to be transferred between accounts, a type of merchandise and or the user's credit score. According to some implementations, the control system may be capable of determining that the level of security indicates that additional data will be required in order to determine whether to authorize the commercial transaction.

Still other innovative aspects of the subject matter described in this disclosure can be implemented in an apparatus that may include a display, a fingerprint acquisition system and a control system. The control system may be capable of controlling the display to present an image indicating an area for a user to touch and of obtaining, via the fingerprint acquisition system, partial fingerprint data from at least a partial finger touch in the area. The partial fingerprint data may correspond to a touching portion of a finger or a thumb. The control system may be capable of comparing the partial fingerprint data with master fingerprint data of a rightful user and of determining, based at least in part on the comparing process, whether to authorize a transaction, start a personalized application, or unlock the apparatus.

In some implementations, the apparatus may include a touch sensing system. The control system may be capable of controlling the display to present one or more purchasing icons on the display. The purchasing icons may correspond to purchasable items. The control system may be capable of receiving, via the touch sensing system, an indication of a dragging movement of the touching portion of the finger or thumb, of controlling the display to move a representation of one of the purchasing icons onto the indicated area, in response to the dragging movement of the touching portion of the finger or thumb, and of determining whether to authorize a transaction.

In some implementations, the control system may be capable of controlling the display to present one or more application icons on the display device. Each of the application icons may correspond to a software application. The control system may be capable of receiving, via the touch sensing system, an indication of a dragging movement of the touching portion of the finger or thumb, of moving a representation of one of the application icons onto the indicated area in response to the dragging movement of the touching portion of the finger or thumb and of determining whether to start an application that corresponds with the representation of one of the application icons.

Still other innovative aspects of the subject matter described in this disclosure can be implemented in an apparatus that may include a display; a touch sensing system; a biometric sensor and a control system. The control system may be capable of controlling the display to present one or more icons and of receiving, via the touch sensing system, an indication that a digit of the user is touching an area of the display device corresponding to one of the presented icons. The control system may be capable of receiving, via the touch sensing system, an indication of a dragging movement of the digit and of controlling the display to move a representation of one of the presented icons onto an area indicating a selection of the icon, in response to the dragging movement of the digit.

The control system may be capable of acquiring biometric information from the digit when the digit is positioned in an area corresponding to the biometric sensor and of invoking a function based on the acquired biometric information. For example, acquiring biometric information may involve obtaining partial fingerprint data from the digit. Invoking the function may involve authorizing a transaction, starting an application or unlocking the apparatus.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1A is a flow diagram that outlines one example of a method of using touch biometrics.

FIGS. 1B and 1C show examples of presenting an image on a display device indicating an area for a user to touch.

FIG. 1D shows an example of a bar code displayed on a display device.

FIG. 1E is a flow diagram of another example of a method of using touch biometrics.

FIGS. 1F and 1G show examples of presenting purchasing icons on a display device and an area for a user to drag the icons.

FIG. 1H is a flow diagram of another example of a method of using touch biometrics.

FIGS. 1I and 1J show examples of presenting application icons on a display device and an area for a user to drag the icons.

FIG. 1K is a flow diagram of another example of a method of using touch biometrics.

FIG. 1L is a flow diagram of another example of a method of using touch biometrics.

FIG. 1M is a flow diagram of another example of a method of using touch biometrics.

FIGS. 2A-2L show examples of fingerprint images corresponding to partial fingerprint data.

FIG. 2M shows an example of an image corresponding to a master fingerprint.

FIG. 3A is a flow diagram that outlines examples of some methods of updating master fingerprint data.

FIG. 3B provides an example of a user holding a mobile display device in a left hand.

FIG. 3C provides an example of a user holding a mobile display device in a right hand.

FIG. 3D provides an example of a user interacting with a mobile display device that is lying on a surface.

FIG. 3E shows another example of a display device that includes a fingerprint acquisition system.

FIG. 4A is a flow diagram that provides an example of determining whether to authorize a transaction based, at least in part, on a level of security.

FIG. 4B is a graph that shows an example of determining a level of security based on a transaction amount.

FIGS. 4C and 4D show examples of device movements that may be captured as device movement data.

FIG. 5 is a block diagram that shows examples of display device components.

FIG. 6A is a block diagram of one example of a touch sensing system.

FIGS. 6B and 6C are schematic representations of examples of the touch sensing system shown in FIG. 6A, with additional details shown of a single sensor pixel.

FIG. 7 is a flow diagram that outlines an example of a process of receiving user input from a force-sensing device and turning an ultrasonic transmitter on or off according to the user input.

FIGS. 8A-8C provide examples of the process outlined in FIG. 7.

FIG. 9A shows an example of an exploded view of a touch sensing system.

FIG. 9B shows an exploded view of an alternative example of a touch sensing system.

FIGS. 10-12 show examples of display devices having an ultrasonic fingerprint sensor positioned outside a display area.

FIGS. 13A and 13B show examples of system block diagrams illustrating a display device that includes a touch sensing system as described herein.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a touch sensing system. In addition, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some implementations described herein use touch biometrics to authenticate a user of a device, such as a mobile display device. In some implementations, an authentication method may involve presenting an image on a display device indicating an area for a user to touch, e.g., to tap. The image may, for example, be an icon associated with an application or “app” that is presented on a display device. The method may involve obtaining at least partial fingerprint data from one or more finger taps or touches in the area. The partial fingerprint data may correspond to a touching portion of a finger or thumb. As used herein, the term “fingerprint” may refer to a fingerprint or a thumbprint.

The method may involve comparing the partial fingerprint data with master fingerprint data of the rightful user and determining, based at least in part on the comparing process, whether to invoke a function. For example, the master fingerprint data may correspond with a relatively more complete fingerprint image that is stored in a memory of, or accessible by, the display device. The function may, for example, involve authorizing a commercial transaction, starting an app, or unlocking the display device. In some implementations, the function may involve authorizing a transaction based on a level of security.

Some such methods may involve obtaining and using touch biometrics, such as fingerprint data and/or finger tap characteristics, in a manner that is transparent to the user. Fingerprint data, finger tap characteristics and/or other biometric data may be obtained and used to enroll and/or authenticate the user while the user is interacting with an application in a normal fashion, e.g. in the native environment of the application. For example, the method may involve presenting an image (such as an icon) on the display device and prompting a user to touch or tap the image in order to make an electronic payment. The payment may be authenticated using biometric information obtained during the touch without the need for the user to be aware of the process.

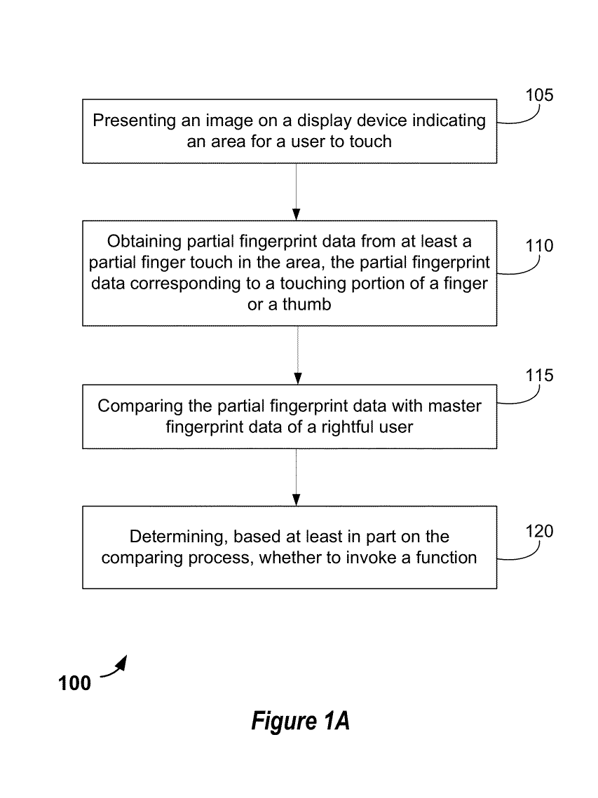

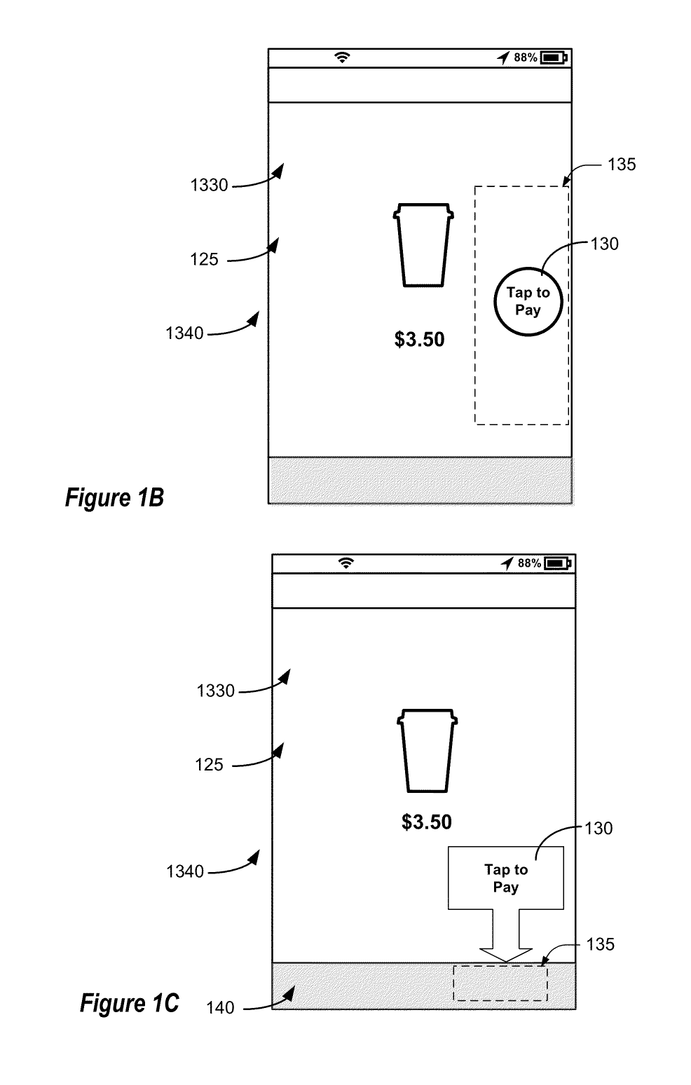

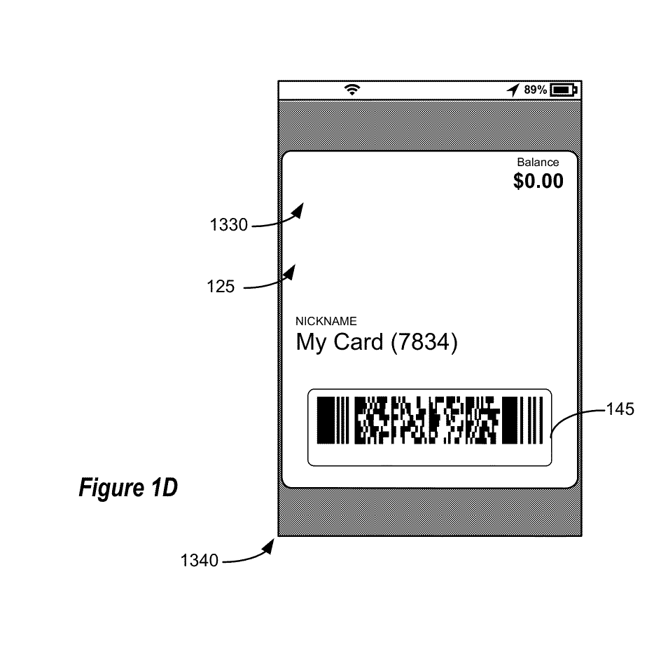

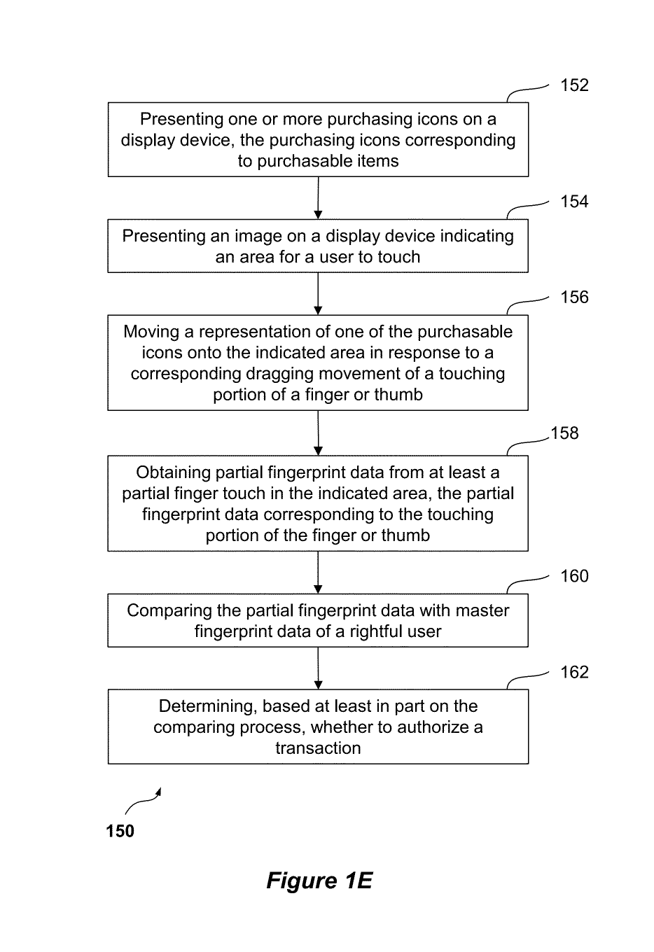

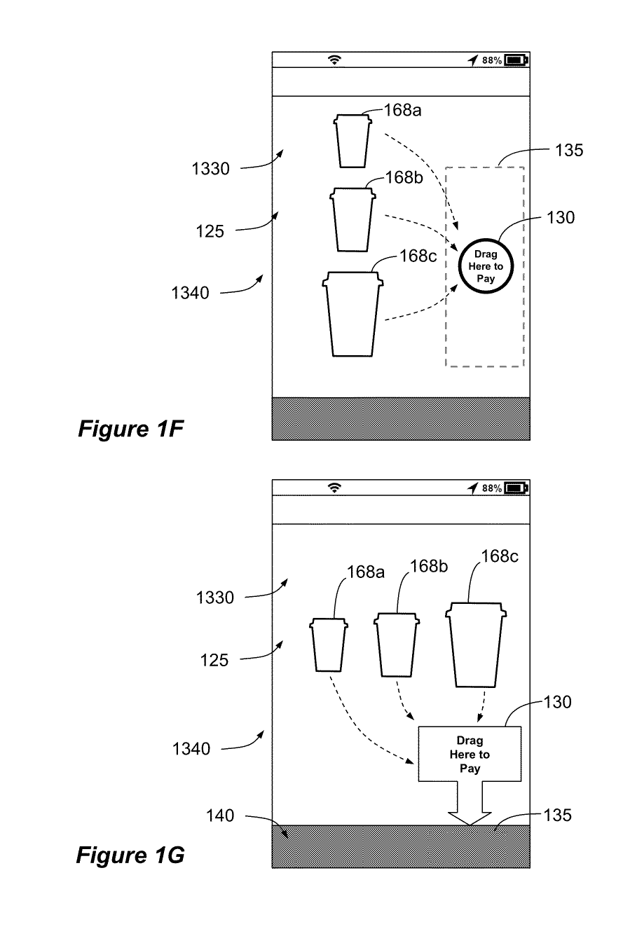

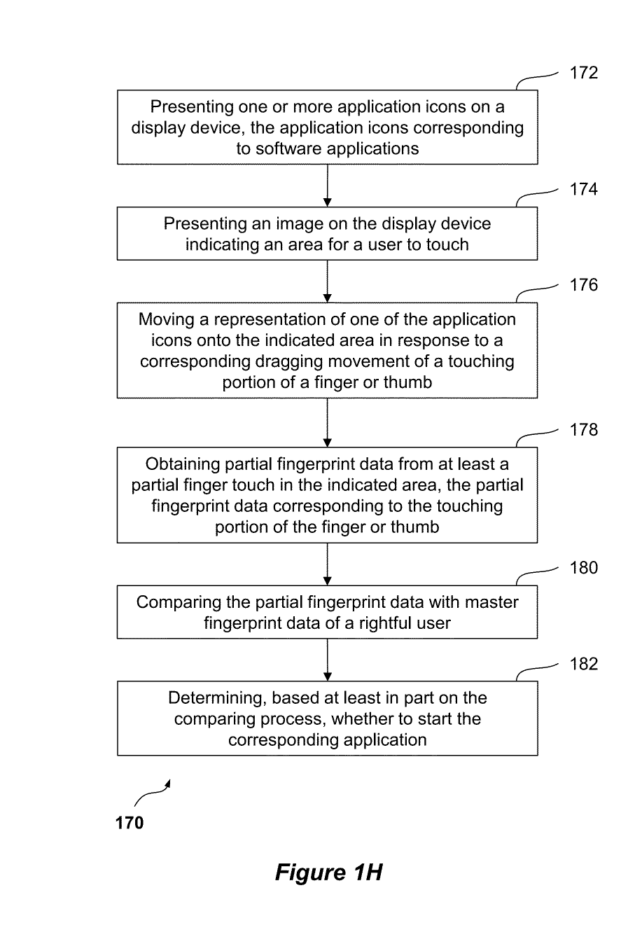

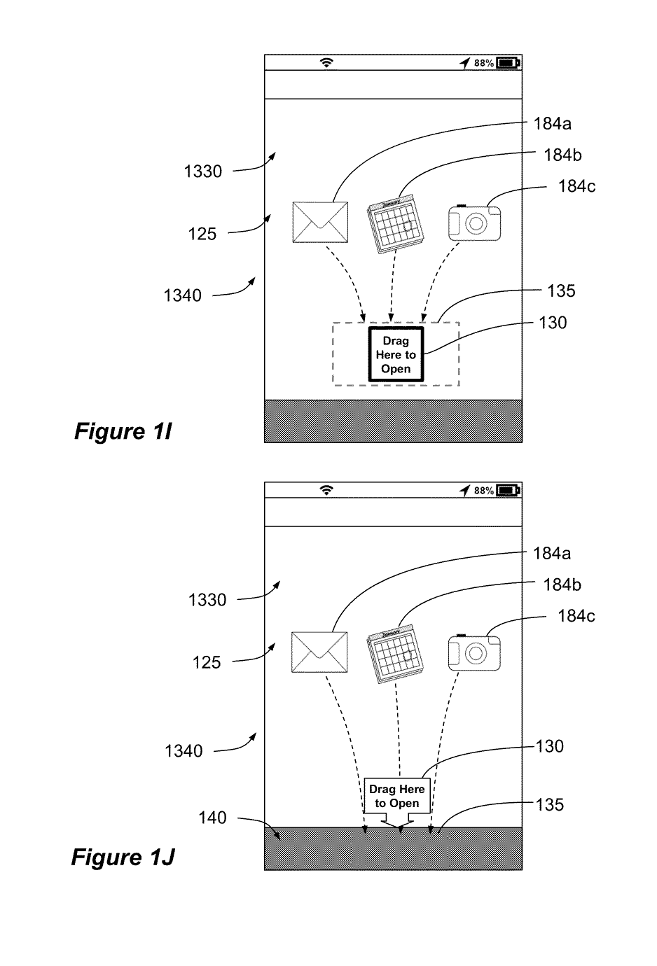

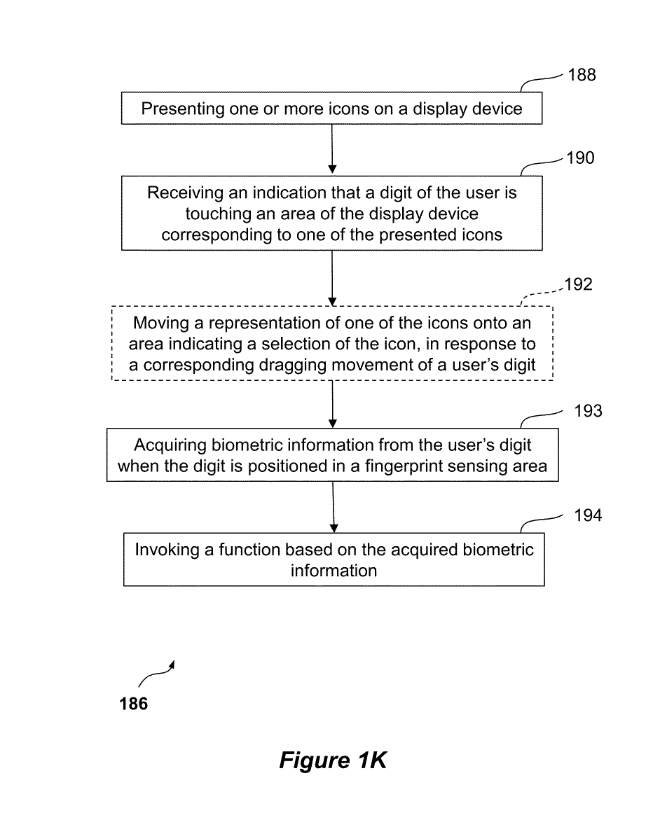

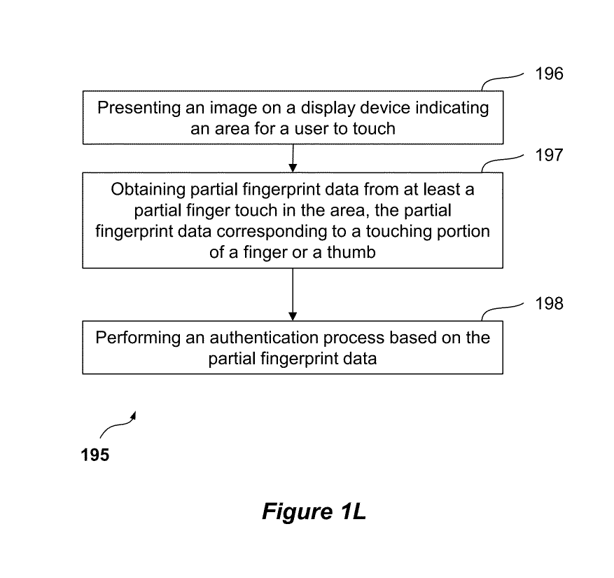

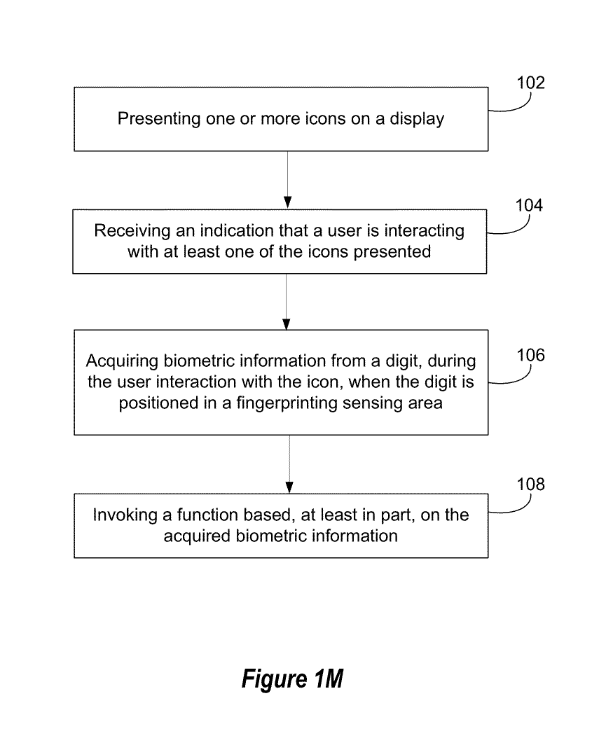

FIG. 1A is a flow diagram that outlines one example of a method of using touch biometrics. The blocks of method 100, like other methods described herein, are not necessarily performed in the order indicated. Moreover, such methods may include more or fewer blocks than shown and/or described. In this example, block 105 involves presenting an image on a display device indicating an area for a user to touch. In some implementations, the image may be an icon, an image of a button, etc., indicating that a user should touch the image itself. Alternatively, the image may indicate another area for the user to touch. The icon may include, for example, an outline of a box indicating where an underlying fingerprint or other biometric sensor may reside. Alternatively, the icon may include, for example, an arrow indicating where a fingerprint or other biometric sensor is positioned relative to the display, such as below or to the side of a display, or on the back or side of a display device enclosure. Alternatively, the image may be a message or instructions for the user to touch an area or perform an action with a biometric or fingerprint sensor, which is known to the user for this purpose. Alternatively, a message may be displayed prompting for an input, which the user understands to mean that the user should touch the fingerprint or other biometric sensor. For example displaying the message “Authenticate,” meaning for an input to a fingerprint or other biometric sensor.

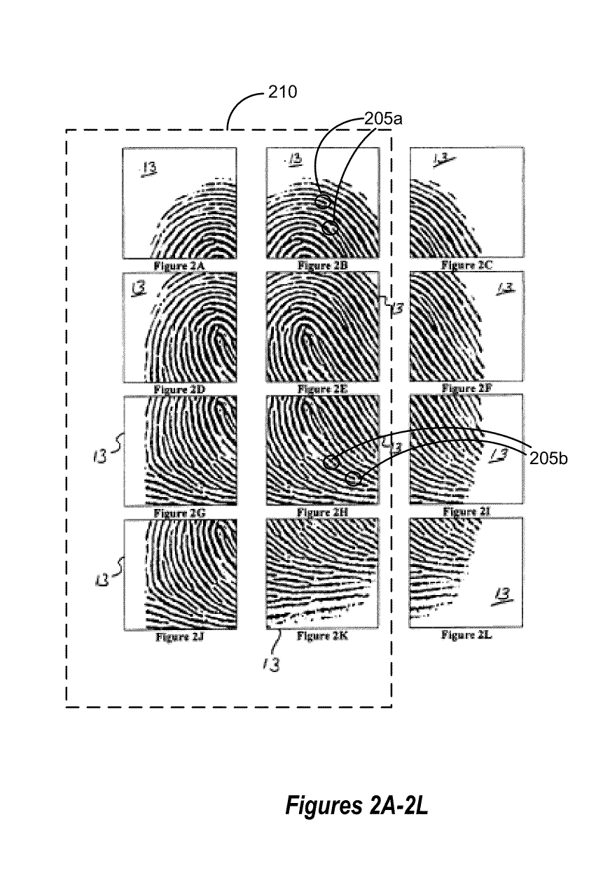

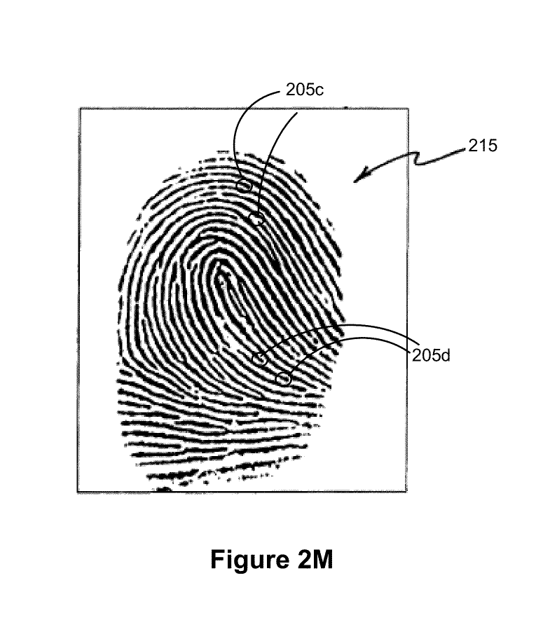

Block 110 involves obtaining partial fingerprint data from at least a partial finger touch in the area. Here, the partial fingerprint data corresponds to a touching portion of a finger or a thumb. As used herein, “fingerprint data” may include various types of data known by those of skill in the various fields of fingerprint identification or “dactyloscopy,” including but not limited to finger or thumb friction ridge image data and data used to characterize fingerprint minutiae, such as data corresponding to the types, locations and/or spacing of fingerprint minutiae. Examples of partial fingerprint data are described below, e.g., with reference to FIGS. 2A-2L. “Partial fingerprint data” may, for example, correspond to only a portion of what will be described below as “substantially complete” or “full” fingerprint data. For example, partial fingerprint data may correspond to ⅔ of a “full” fingerprint, less than half, less than 25%, or even less than 10%.

In this example, block 115 involves comparing the partial fingerprint data with master fingerprint data of a rightful user. The master fingerprint data may have been obtained during an enrollment process, during which a rightful user provided “full,” or substantially complete, fingerprint data for one or more fingers and/or thumbs. The terms “full fingerprint data” and “substantially complete fingerprint data” may be used interchangeably herein. These terms may, for example, correspond to fingerprint data that may be obtained by placing a finger or thumb in a substantially flat position over an area corresponding to a fingerprint acquisition system, by “rolling” the finger or thumb over such an area, etc. It will be understood that “full” or “substantially complete” fingerprint data does not necessarily mean fingerprint data corresponding to each and every friction ridge or whorl of a finger or thumb. Some such implementations may involve prompting the rightful user to provide full fingerprint data for at least one finger, associating the full fingerprint data with the rightful user and storing the full fingerprint data in a memory. Such full fingerprint data may be stored as at least part of the master fingerprint data. In some implementations, for example, full fingerprint data for one finger may be aggregated with full fingerprint data for at least one other finger, thumb, etc., as the master fingerprint data. Fingerprint data may include portions of one or more fingertips near the fingernail, representative of where an individual might physically touch a touchscreen of a mobile device.

However, as described below, some implementations involve obtaining, augmenting, adapting and/or updating master fingerprint data while a user is performing other operations with a display device, such as tapping a touch panel while interacting with other software applications on a display device (such as browsing the Internet, using a cellular telephone, making commercial transactions, etc.).

The master fingerprint data may be stored locally, e.g., in a memory of a display device. Alternatively, or additionally, the master fingerprint data may be stored in another device, such as a memory device accessible via a data network. For example, the master fingerprint data may be stored on a memory device of, or a memory device accessible by, a server.

In this example, block 120 involves determining, based at least in part on the comparing process of block 115, whether to invoke a function. Invoking the function may, for example, involve authorizing a transaction such as a commercial transaction. In some implementations, invoking the function may involve starting a personalized application or unlocking the display device. In some implementations, a personalized application may be a personal email account, a personal calendar, or an application displaying a dashboard of a user's physical activity, e.g., number of steps and calories burned that may be measured by an activity sensor worn on the body of the user. In some implementations, the personalized application may be a virtual private network (VPN) and invoking the function may involve establishing the VPN. According to some such implementations, a VPN may be established based only upon the partial fingerprint data, whereas in alternative implementations further information, such as a user ID and/or pass code, may need to be provided and evaluated before the VPN can be established.

In some implementations, block 120 may involve invoking computer software for fingerprint identification, which also may be referred to as fingerprint individualization. Such software may be stored on a non-transitory medium, such as a portion of a memory system of a display device. Alternatively, or additionally, at least some of the related software may be stored in a memory system of another device that the display device may be capable of accessing, e.g., via a data network. Such fingerprint identification software may, for example, include instructions for controlling one or more devices to apply threshold scoring rules to determine whether the master fingerprint data and the partial fingerprint data correspond to the same finger(s) or thumb(s). The scoring rules may, for example, pertain to comparing the types, locations and/or spacing of fingerprint minutiae indicated by the master fingerprint data and the partial fingerprint data.

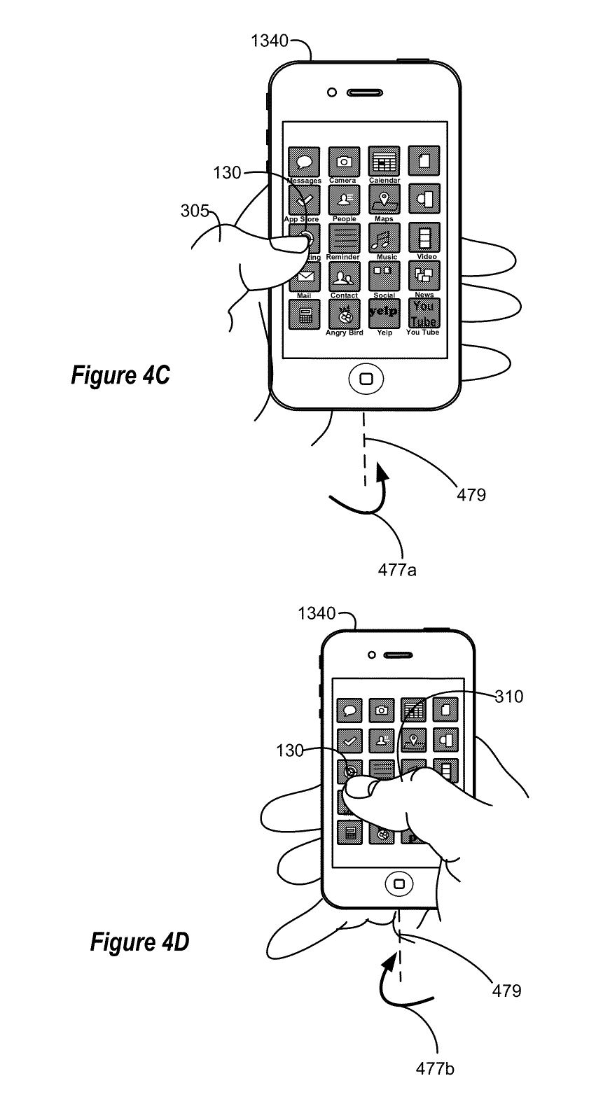

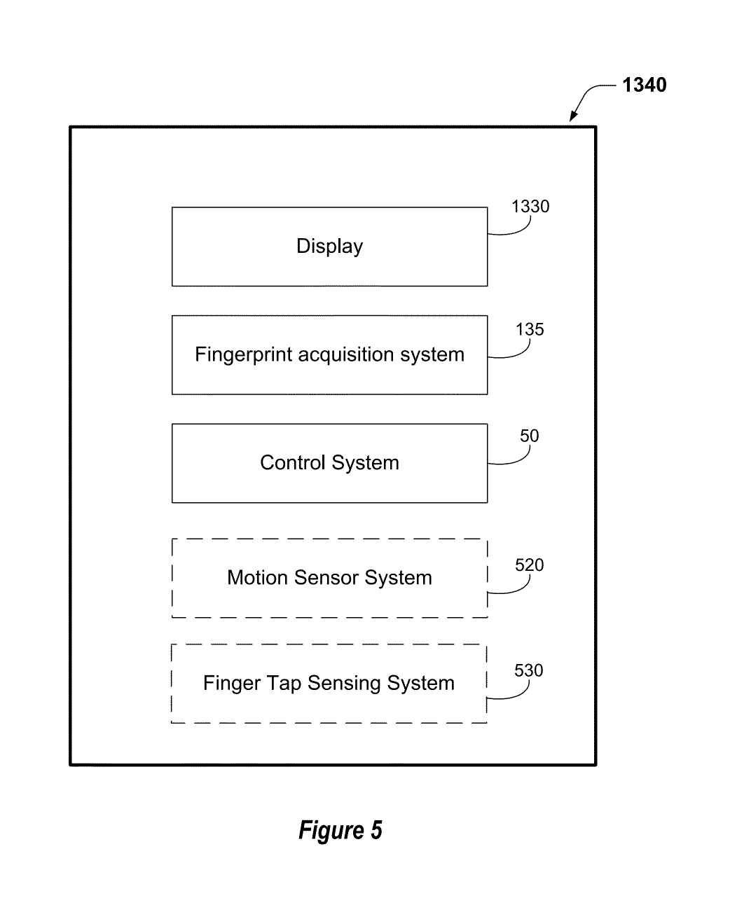

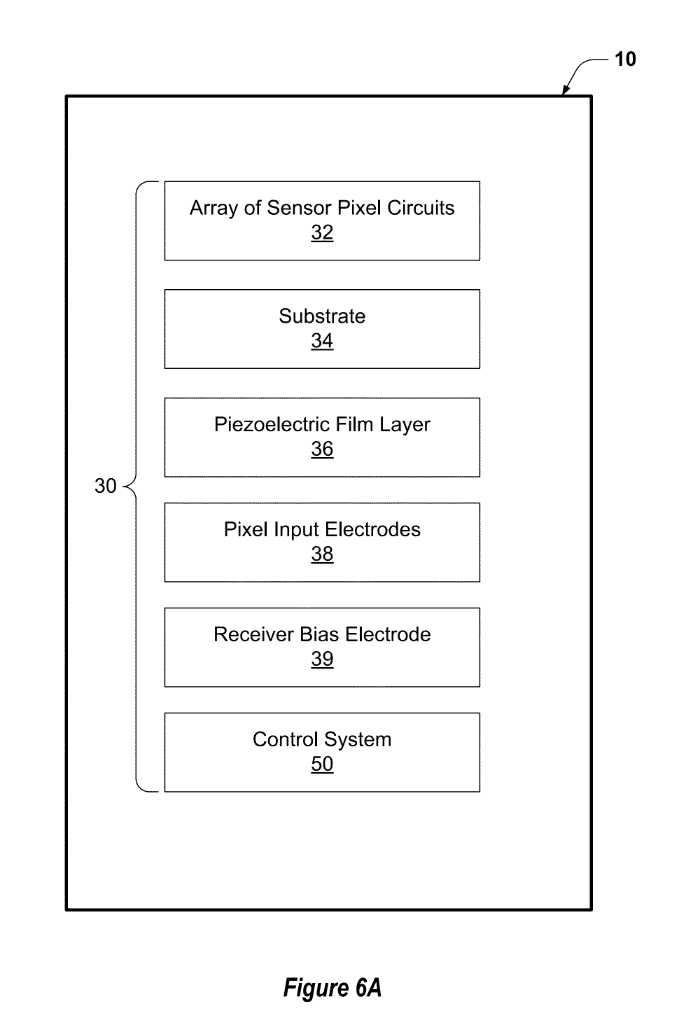

In some implementations, additional types of authentication data may be evaluated in method 100 and/or other methods described herein. In some such implementations, additional types of authentication data may be evaluated because the determination of whether to invoke the function (block 120 of FIG. 1A) may, for example, involve determining whether to authorize a transaction based on a level of security. As described in more detail below with reference to FIG. 4A, higher levels of security may correspond with evaluating additional types of authentication data in the process of determining whether to invoke a function, such as determining whether to authorize a transaction.

For example, in some implementations finger tap characteristic data may be evaluated to determine whether the finger tap characteristic data corresponds with finger tap characteristic data of a rightful user. Finger tap characteristic data may, for example, correspond with a frequency of taps (e.g., as measured by the average time interval between taps) and/or a number of taps (e.g., as measured by the average number of taps during a predetermined time interval, the pressure of the tap or the dwell of the tap). Accordingly, the frequency of taps and/or number of taps can indicate how quickly the user normally taps on the display device, e.g., when interacting with one or more graphic user interfaces displayed on the display device (e.g., when interacting with a keypad).

The frequency of taps and/or number of taps may be determined by a finger tap sensing system. In some implementations, the finger tap sensing apparatus may include a microphone of a display device. In some implementations, the finger tap sensing system may include a touch sensing system of the display device, including but not limited to the types of touch sensing systems described herein.

In some implementations, finger tap characteristic data may be based, at least in part, on an audio signature of the rightful user's finger taps. For example, some users may normally have relatively longer fingernails. The sound produced by tapping on a display device with a fingertip that includes a fingernail will differ from the sound produced by tapping on a display device with a fingertip that does not include a fingernail. Relatively thinner fingers will produce different tapping sounds than relatively fleshy, fat fingers. Larger fingers will tend to produce different tapping sounds than relatively smaller fingers. A microphone of a display device may be used to capture audio data corresponding to a rightful user's tapping sounds, e.g., during an enrollment period or during routine use of the display device.

Based, at least in part, on audio data corresponding to the tapping sounds, a control system of the display device (or of another device) may determine an audio signature of the rightful user's finger taps. For example, a control system may be capable of transforming the audio data from the time domain into the frequency domain. The control system may be capable of dividing the frequency domain data into a predetermined number of frequency ranges and of determining the power corresponding to the audio data in each of the frequency ranges. In such implementations, an audio signature of the rightful user's finger taps may be based, at least in part, on the power in each of the frequency ranges. For example, audio signature of the rightful user's finger taps may be based, at least in part, on the average power in each of the frequency ranges. The resulting audio signature may be used during an authentication process, e.g., by comparing the audio signature of the rightful user's finger taps with an audio signature of a person currently using the display device. In some implementations, a sequence of taps such as tap-tap-pause-tap may be sensed and compared to a stored sequence to determine a rightful user and invoke a function when the sequence is matched.

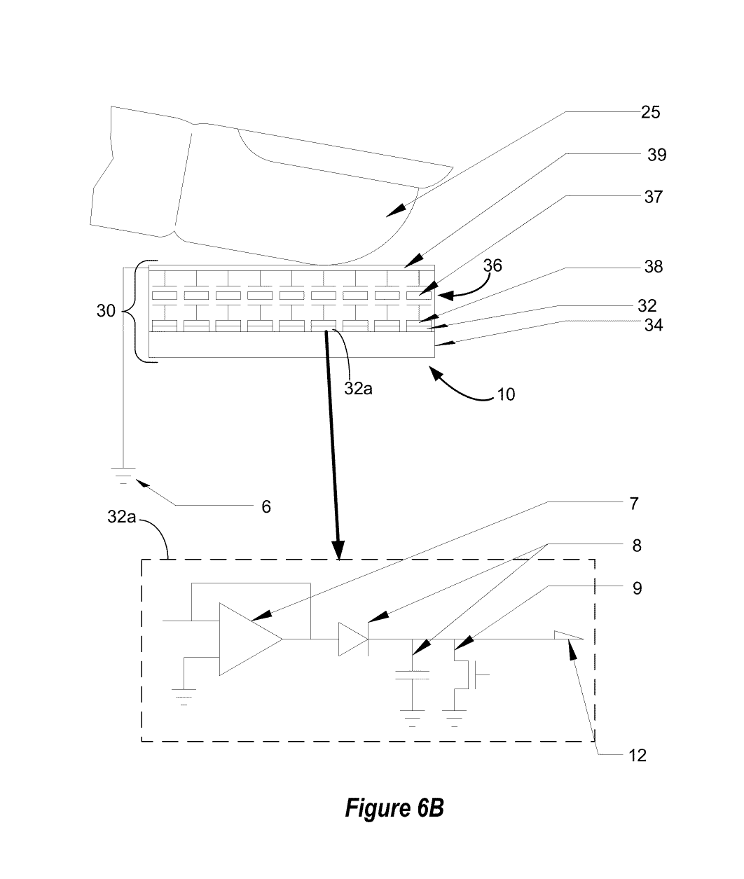

Accordingly, the determination of whether to invoke a function (in block 120 of FIG. 1A) may be based, at least in part, on evaluating finger tap characteristic data. Alternatively, or additionally, method 100 may involve receiving device movement data and the determining process of block 120 may be based, at least in part, on the device movement data. Examples of device movement data are described below, e.g., with reference to FIGS. 4B-5.

FIGS. 1B and 1C show examples of presenting an image on a display device indicating an area for a user to touch. Accordingly, FIGS. 1B and 1C provide examples of block 105 of FIG. 1A. In FIGS. 1B and 1C, the display devices 1340 are presenting images associated with a commercial transaction. In the examples shown in FIGS. 1B and 1C, the commercial transaction involves purchasing coffee. Therefore, a cup of coffee and the price are shown on the display areas 125 of the display devices 1340.

In the implementation shown in FIG. 1B, the image 130 is an icon indicating that a user should touch the area in which the image 130 is displayed. The image 130 may be presented as part of a third-party software application or “app” for purchasing coffee online. For example, the software may be an app that a user has downloaded to the display device 1340 from an app store or from a website of company such as Starbucks™, Peet's™, etc. When the user touches or taps in the area corresponding to the image 130, a touch panel of the display device 1340 may detect the user's touch. The app may control the display device 1340 to send a signal via a data network indicating that the user desires to purchase a coffee for the price indicated on the display device 1340. The signal may, for example, be sent to a server controlled by the company that provided the app.

However, in addition to providing functionality for the app, partial fingerprint data may be obtained when the user touches or taps a touching portion of a finger or a thumb in the area of the image 130. Accordingly, this process is an example of block 110 of FIG. 1A. In some implementations, enrollment is performed in the natural use environment of the app. The app may or may not relate to authentication functionality. The enrollment may be performed incrementally by obtaining correlating, and aggregating partial fingerprint data obtained whenever a user touches or taps a touching portion of a finger or a thumb in the area of the image 130.

For example, block 105 of FIG. 1A may involve presenting an icon associated with a first software application that does not relate to authentication functionality. If it is determined in block 115 that the partial fingerprint data correspond with master fingerprint data of the rightful user, method 100 may involve determining whether to update the master fingerprint data to include the new fingerprint data, even if no authentication process is currently being used in connection with the first software application. According to such methods, enrollment may take place, at least in part, in a natural usage environment of the first software application, in contrast to a dialog format where user is given explicit enrollment instructions.

Other types of authentication data may be obtained in a similar fashion. For example, such methods may involve obtaining new finger tap characteristic data while the rightful user is using a software application that does not relate to authentication functionality. The determining process of method 100 may involve determining whether to update existing finger tap characteristic data of the rightful user according to the new finger tap characteristic data. Similarly, such methods may involve obtaining new device movement data while the rightful user is using a software application that does not relate to authentication functionality. The determining process of method 100 may involve determining whether to update existing device movement data of the rightful user according to the new device movement data.

Referring again to FIG. 1B, in this example, the partial fingerprint data are obtained by a fingerprint acquisition system 135 that is positioned within in a portion of the display area 125. The size and position of the fingerprint acquisition systems 135 shown in FIGS. 1B and 1C are merely examples. The fingerprint acquisition system 135 may, for example, include an optical fingerprint sensor, a capacitive fingerprint sensor, an ultrasonic fingerprint sensor or any other appropriate type of fingerprint sensor.

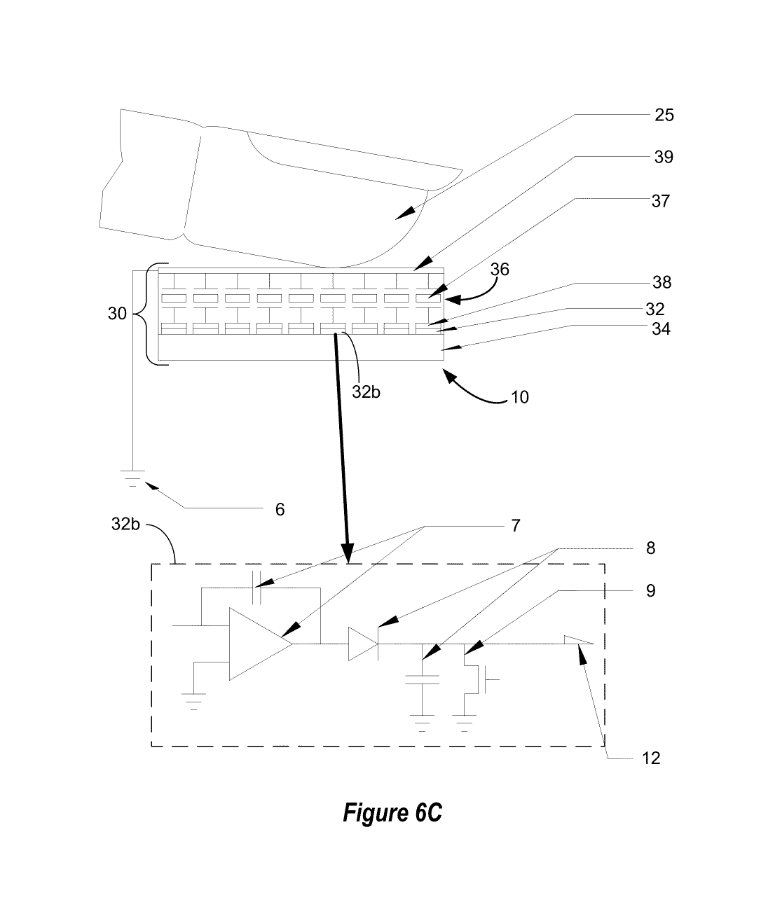

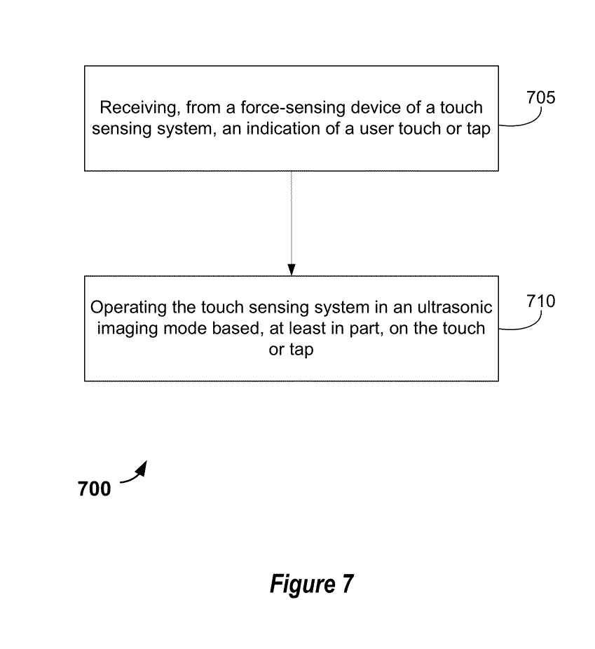

Accordingly, in some implementations, block 110 of FIG. 1A involves an ultrasonic imaging process. Some examples of ultrasonic fingerprint acquisition systems and related devices are described below, with reference to FIGS. 6A-12. As described below, with some such implementations block 110 may involve obtaining the partial fingerprint data via an ultrasonic sensor array with an ultrasonic transmitter for generating ultrasonic waves. In some implementations, the fingerprint data may be obtained while maintaining the ultrasonic transmitter in an “off” state.

In alternative implementations, the image 130 may indicate another area for the user to touch. In the example shown in FIG. 1C, the image 130 is an icon indicating that a user should touch an area adjacent to that in which the image 130 is displayed. In this implementation, the image 130 is indicating that a user should touch an area that is outside of the display area 125, such as in a border area 140. In some implementations, the border area 140 may include opaque material through which visible light may not penetrate. For example, the border area 140 may often be covered by an opaque case or “skin.” In some implementations, the border area 140 of the display device itself may be substantially opaque to visible light.

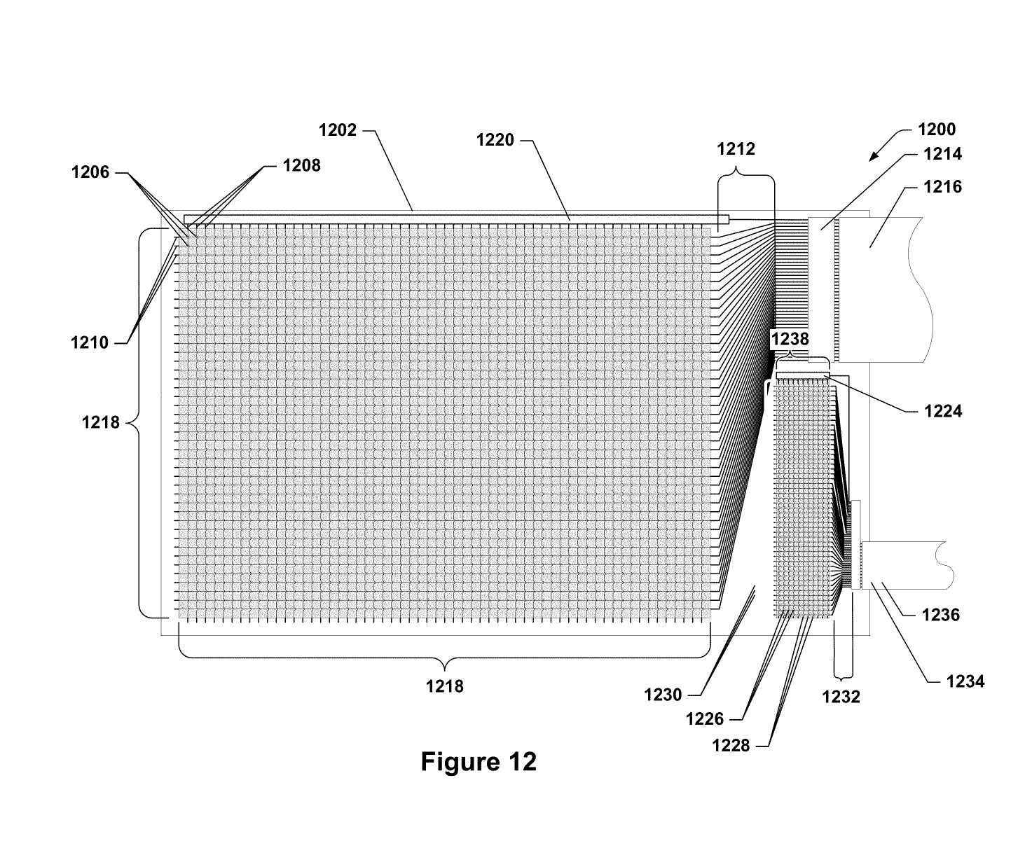

Accordingly, in this example the fingerprint acquisition system 135 may include a type of fingerprint sensor that is capable of obtaining fingerprint data through substantially opaque material. In some implementations, for example, the fingerprint acquisition system 135 may include an ultrasonic fingerprint sensor. Examples of display devices having an ultrasonic finger print sensor positioned outside of a display area are described below with reference to FIGS. 10-12.

FIG. 1D shows an example of a bar code displayed on a display device. In this example, the rightful user of the display device 1340 has provided partial fingerprint data while using one of the coffee-purchasing apps described above with reference to FIGS. 1B and 1C. Accordingly, when the partial fingerprint data were compared with the rightful user's master fingerprint data in block 115 of FIG. 1A, the commercial transaction was authorized in block 120, e.g., by the display device 1340 or by a server under the control of the entity that provided the coffee-purchasing app. In this example, the display device 1340 receives an authorization signal for the coffee purchase from such a server via a data network. The display device 1340 is capable of controlling the display 1330, pursuant to instructions of the coffee-purchasing app, to present an image of a bar code 145 in response to the authorization signal. The bar code 145, which may represent a user's account number, may be used to obtain a cup of coffee at a participating café.

FIG. 1E is a flow diagram of another example of a method of using touch biometrics. In this example, block 152 of method 150 involves presenting one or more purchasing icons on a display device. The purchasing icons may correspond or be associated with one or more purchasable items such as items from an on-line store. The purchasing icons may contain text, graphics, photos, images, or other suitable indicators of the purchasable items. As indicated in block 154 and as described above with respect to block 105, a user may be presented with an image on the display device indicating an area for the user to touch. In this example, the user may touch the indicated area by first touching a purchasing icon associated with an item to be purchased with a touching portion of a finger or thumb. A representation of the icon may be moved towards, over or otherwise onto the indicated area in response to a corresponding dragging movement of the touching portion of a finger or thumb as described in block 156. The display may simulate a “dragging” operation corresponding to the dragging movement of the user's finger or thumb by updating the position of the purchasing icon to follow the finger of the user as the icon is dragged towards the indicated area. As described earlier with respect to block 105, the indicated area may be within the display area or outside the display area, such as in a bezel area near the periphery of the active display area where a biometric sensor such as a fingerprint acquisition system is positioned. As shown in block 158, partial fingerprint data from at least a partial finger touch in the indicated area may be obtained. The partial fingerprint data may correspond to a touching portion of a finger or a thumb. When the fingerprint data is acquired, the purchasing icon and perhaps the image indicating where the user should touch may disappear, at least for a time. For example, the purchasing icon or the image representing the sensor area may appear when authorization may occur, and disappear after fingerprint data has been acquired to minimize false operations. As shown in block 160, the partial fingerprint data may be compared with master fingerprint data of a rightful user. As shown in block 162, a determination whether to authorize a transaction may be based at least in part on the comparing process.

FIG. 1F shows an example of presenting purchasing icons on a display device and an area for a user to drag the icons. Although the “dragging” operation may sometimes be described as being performed by the user, it will be appreciated that a dragging operation generally involves a display device controlling a display to move a graphical representation of, e.g., an icon in response to a corresponding dragging movement of a user's digit. Multiple purchasing icons 168a, 168b and 168c are shown on a display 1330 of a display device 1340. Should a user wish to purchase an item associated with purchasing icons 168a, 168b or 168c, the user may place a portion of a finger or thumb on a surface of the display 1330 over the selected purchasing icon. A representation of the selected icon may be moved towards, over or otherwise onto the indicated area (as indicated by an image 130) in response to a corresponding dragging movement of the touching portion of a finger or thumb. The indicated area (here, image 130) may correspond with an area of a fingerprint acquisition system 135 that is positioned within a portion of the display area 125. When over the fingerprint acquisition system 135, an image of the user's finger may be acquired and used to authenticate the user and authorize the transaction.

FIG. 1G shows another example of presenting purchasing icons on a display device and an area for a user to drag the icons. Should a user wish to purchase one or more items associated with purchasing icons 168, the user may place a portion of a finger or thumb on a surface of the display 1330 over the desired purchasing icon 168. A representation of the selected icon may be moved, in response to a corresponding dragging movement of the touching portion of a finger or thumb, towards an edge of the display area 125 (as indicated by the image 130). The user may be prompted to move the touching portion of a finger or thumb onto a fingerprint acquisition system 135 positioned outside the display area 125, such as in a bezel or border area 140 of the display device 1340.

FIG. 1H is a flow diagram of another example of a method of using touch biometrics. In this example, block 172 of method 170 involves presenting one or more application icons on a display device. The application icons may correspond or be associated with one or more software applications running on a mobile device, such as a personal email application, a personal calendar application, or a personal photo application. The application icons may contain text, graphics, photos, images, or other suitable indicators of the applications. As indicated in block 174 and as described above with respect to block 105, a user may be presented with an image on the display device indicating an area for the user to touch. In this example, the user may touch the indicated area by first touching an application icon associated with an application with a touching portion of a finger or thumb. A representation of the icon may be moved towards, over or otherwise onto the indicated area in response to a corresponding dragging movement of the touching portion of a finger or thumb as described in block 176. The position of the application icon may be updated on the display to follow the dragging movement of the touching portion of the finger or thumb, to provide a simulation of the icon being dragged towards the indicated area. As described earlier with respect to block 105, the indicated area may be within the display area or outside the display area, such as in a bezel area near the periphery of the active display area where a biometric sensor such as a fingerprint acquisition system is positioned. As shown in block 178, partial fingerprint data from at least a partial finger touch in the indicated area may be obtained. The partial fingerprint data may correspond to a touching portion of a finger or a thumb. When the fingerprint data is acquired, the application icon (and, in some implementations, the image indicating where the user should touch) may disappear, at least for a time. For example, the application icon or the image representing the sensor area may appear when launching of the application may occur, and disappear after fingerprint data has been acquired to minimize false operations. As shown in block 180, the partial fingerprint data may be compared with master fingerprint data of a rightful user. As shown in block 182, a determination whether to start an application may be based at least in part on the comparing process.

FIG. 1I shows an example of presenting application icons on a display device and an area for a user to drag the icons. Multiple application icons 184a, 184b and 184c are shown on a display 1330 of a display device 1340. Should a user wish to launch, open or otherwise start a software application associated with application icons 184a, 184b or 184c, the user may place a portion of a finger or thumb on a surface of the display 1330 over the selected application icon. A representation of the selected icon may be moved towards, over or otherwise onto an area of a fingerprint acquisition system 135 that is positioned within a portion of the display area 125 (as indicated by an image 130), in response to a corresponding dragging movement of the touching portion of a finger or thumb. When the touching portion of a finger or thumb is positioned over the fingerprint acquisition system 135, an image of at least a portion of the user's finger or thumb may be acquired and used to authenticate the user and start the application.

FIG. 1J shows another example of presenting application icons on a display device and an area for a user to drag the icons. Should a user wish to launch, open or otherwise start a software application associated with application icons 184, the user may place a portion of a finger or thumb on a surface of the display 1330 over the desired application icon 184. A representation of the desired application icon 184 may be moved, in response to a corresponding dragging movement of the touching portion of the finger or thumb, towards an edge of the display area 125 (as indicated by the image 130). The user may be prompted to place the touching portion of the finger or thumb onto a fingerprint acquisition system 135 positioned outside the display area 125, such as in a bezel or border area 140 of the display device 1340.

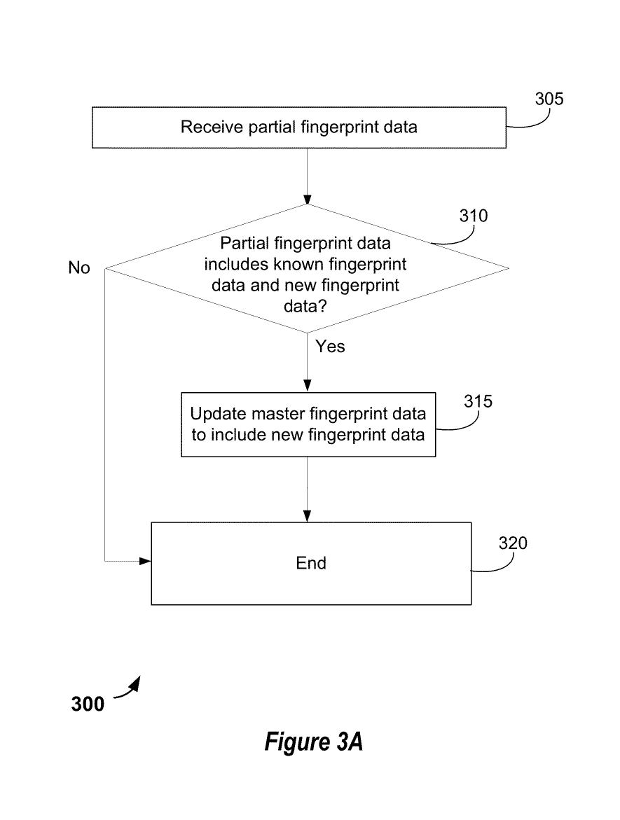

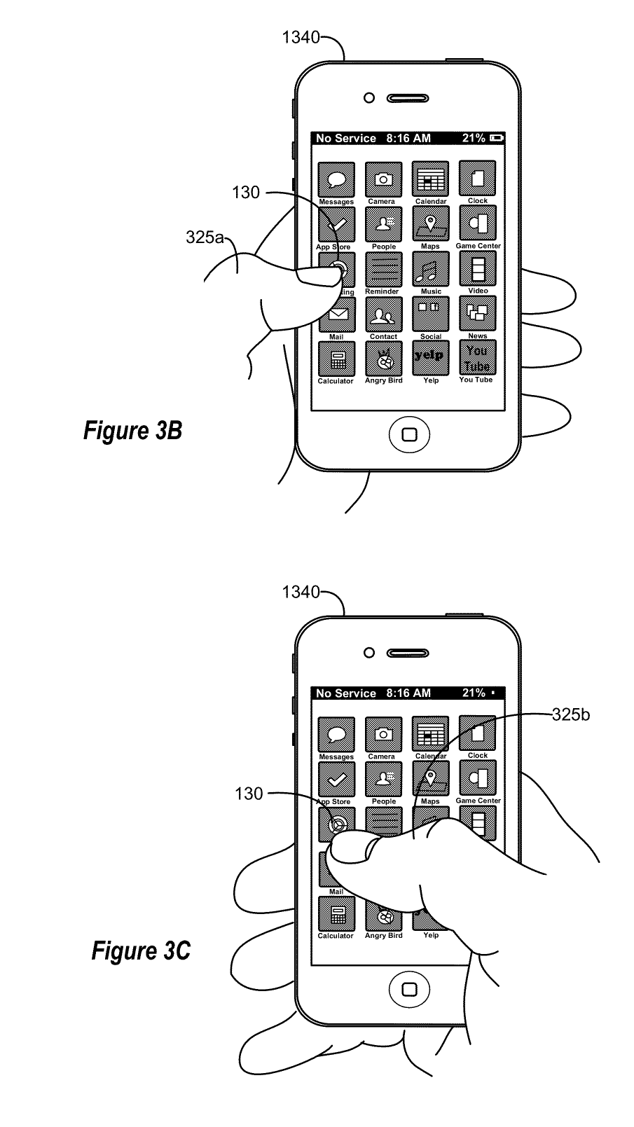

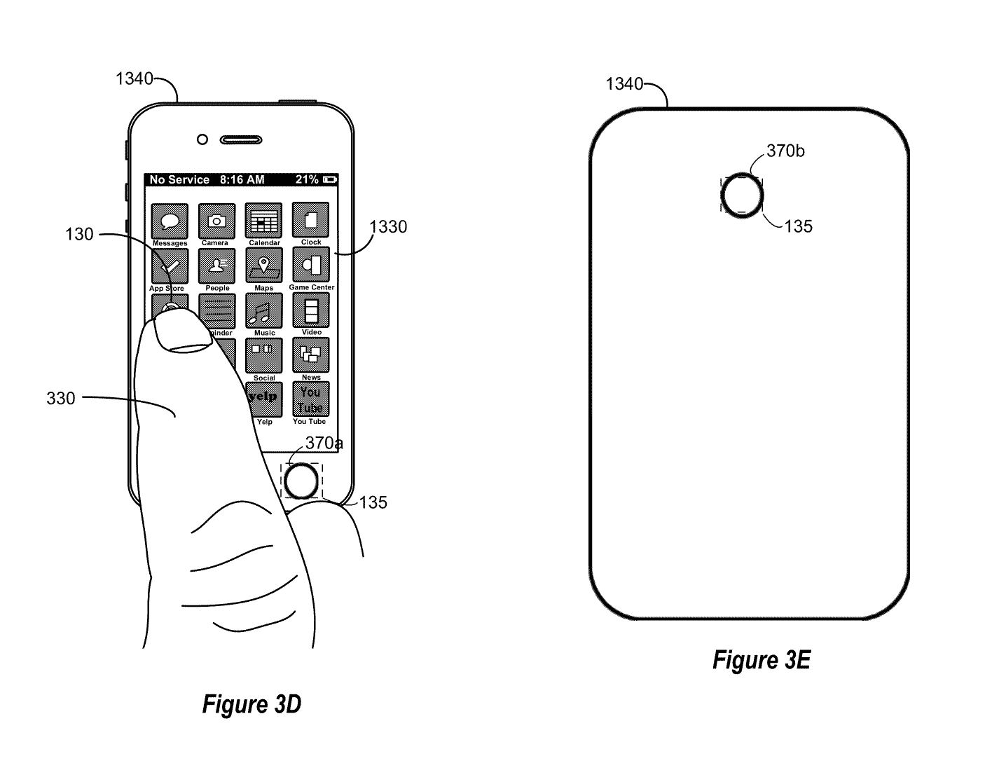

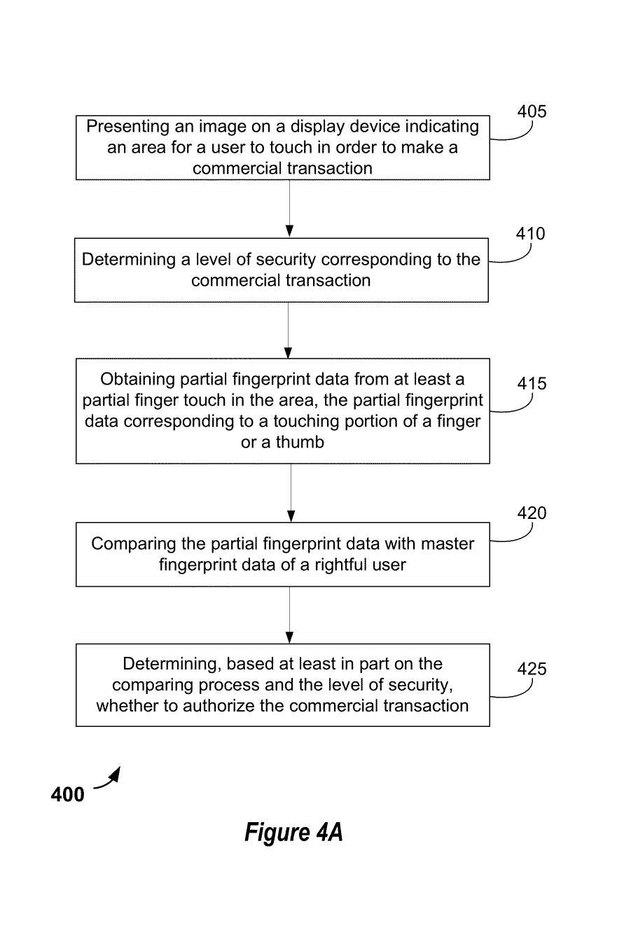

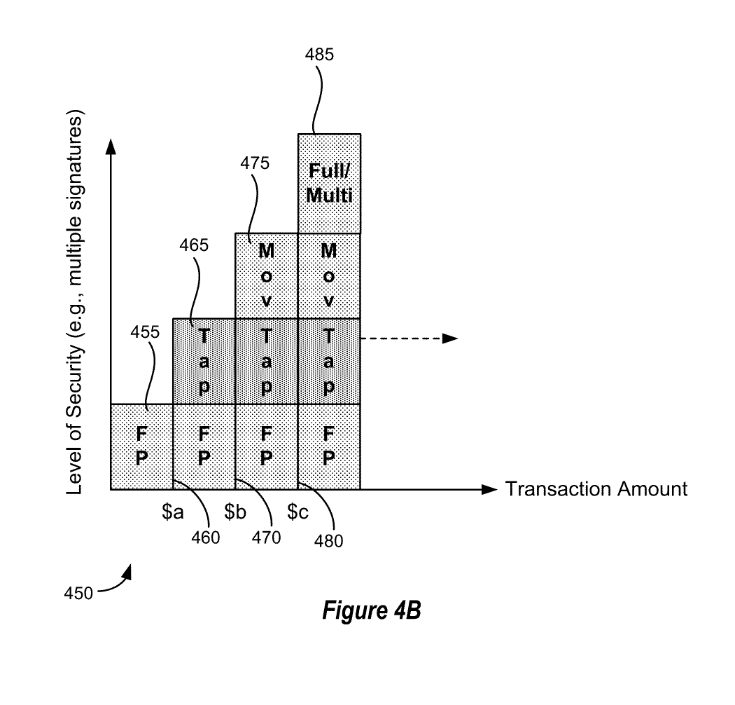

FIG. 1K is a flow diagram of another example of a method of using touch biometrics. In this example, block 188 of method 186 for biometric authorization involves presenting one or more icons on a display device. The icons may correspond or be associated with, for example, one or more software applications running on a mobile device or one or more purchasable items from an on-line store. The icons may contain text, graphics, photos, images, or other suitable indicators of the applications or purchasable items. A user may select one of the presented icons with a portion of digit, such as a finger or thumb. Accordingly, in this example block 190 involves receiving an indication that a digit of the user is touching an area of the display device corresponding to one of the presented icons. As shown in optional block 192, a representation of the selected icon may be moved towards, over or otherwise onto an area indicating a selection of the icon, in response to a corresponding dragging movement of the user's digit. The position of the icon may be updated on the display to follow the finger of the user to create the impression that the icon is being dragged towards the indicated area. Alternatively, the display may show a copy or an impression of the selected icon and the position of the copy or impression updated as the icon is dragged towards the indicated area. As described earlier with respect to block 105, the indicated area may be within the display area or outside the display area, such as in a bezel area near the periphery of the active display area where a biometric sensor such as a fingerprint acquisition system is positioned so that biometric information may be acquired. As shown in block 193, biometric information such as full or partial fingerprint data may be acquired when at least a portion of the digit of the user is positioned in the indicated area. Accordingly, in some implementations the biometric information may be acquired, at least in part, in one or more fingerprint sensing areas of a fingerprint acquisition system, such as the fingerprint acquisition systems 135 discussed elsewhere herein. The fingerprinting sensing area may be within an area of a display that is presenting the icons or in a border area outside of the display. In some implementations, the display may be on a front side of a display device and the fingerprinting sensing area may be on a back side of the display device. If the fingerprinting sensing area is an area outside the display or on the back of the display device, the display device may, for example, provide an audio and/or visual prompt to the user to touch the area. As shown in FIGS. 3D and 3E and described below, some implementations include a button that corresponds, at least in part, with a fingerprinting sensing area. In block 194, a function may be invoked (for example, a transaction may be authorized or an application may be started) based on the acquired biometric information.

FIG. 1L is a flow diagram of another example of a method of using touch biometrics. In this example, block 196 of method 195 for biometric authentication involves presenting an image on a display device indicating an area for a user to touch. The image may, in some examples, correspond to one or more icons that may correspond or be associated with one or more software applications running on a mobile device or one or more purchasable items from an on-line store. The image may contain text, graphics, photos, images, or other suitable indicators of applications or purchasable items, or may simply indicate (e.g., with text, an arrow, etc.) an area of the display, of a peripheral area outside of the display or on the back of the display, for the user to touch. As shown in block 197, partial fingerprint data may be acquired from at least a partial finger touch in the area. The partial fingerprint data may correspond to a touching portion of a finger or a thumb. As shown in block 198, an authentication process may be performed based, at least in part, on the partial fingerprint data. Various examples of such authentication processes are provided herein. Based on the authentication process, it may be determined whether a function will be invoked. The function may involve authorizing a transaction, starting a personalized application, unlocking the display device, etc.

FIG. 1M is a flow diagram of another example of a method of using touch biometrics. In this example, block 102 involves presenting one or more icons on a display. In some implementations, the icons may correspond with software applications. Alternatively, or additionally, the icons may correspond with purchasable items. In this example, block 104 involves receiving an indication that a user is interacting with at least one of the icons presented. Block 104 may involve receiving an indication that the digit is touching an area of the display corresponding to one of the presented icons. For example, the indication may be received via a touch sensing system. In some implementations, block 104 may involve receiving an indication of a dragging motion of the digit towards an indicated area. In some examples, the indicated area may be displayed on the display. However, in other examples, the indicated area may be on the edge of the display, on a side of a device that includes the display, on the back of a device that includes the display, etc. Block 104 may involve receiving an indication that the user has tapped on the icon a number of times and/or within a range of time intervals. In this implementation, block 106 involves acquiring biometric information from a digit, during the user interaction with the icon, when the digit is positioned in a fingerprinting sensing area. For example, the biometric information may be acquired via a fingerprint acquisition system or via another type of biometric sensor system. The acquiring may involve obtaining partial fingerprint data from the digit. Here, block 108 involves invoking a function based, at least in part, on the acquired biometric information. For example, block 108 may involve an authentication process that is based, at least in part, on the acquired biometric information.

Methods of biometric authorization using a select and drag operation on a display screen may allow safe selection or secure selection when opening a personalized application or purchasing an on-line item so that a user may feel safe or secure. For example, a user may open an email account, access a personal calendar, view a personal stock portfolio, or view a video by simply selecting an appropriate icon and dragging the selected icon to an authenticating region where biometric information may be acquired and the application started or an operation performed. The user may feel very secure when performing such an operation in this manner. Other applications or folders such as those containing personal information may be opened similarly. In other implementations, bio-secure applications or file folders may be selected and accessed with a drag and authenticate operation.

Methods of biometric authorization using a select and drag operation may allow rapid, secure purchases of on-line items. In a manner reminiscent of yet different from a “one-click” purchasing method, a user may select and drag an icon associated with a purchasable item onto an authenticating region of a mobile device in a “one-drag” purchasing method according to one implementation of the present invention.

In alternative arrangements, a user may select an icon on a display device that becomes highlighted, and then touch or partially touch an indicated area on the display device for the acquisition of biometric information. Pending successful matching of the biometric information, an application associated with the selected icon may be started, a selected item may be purchased, or an operation may be performed.

FIGS. 2A-2L show examples of fingerprint images corresponding to partial fingerprint data. In this example, FIGS. 2A-2L are a group of partial fingerprint images 13 that have been obtained during multiple iterations of a process such as that of block 110 of FIG. 1A. During this process, partial fingerprint data corresponding to the partial fingerprint images 13 may be obtained. The partial fingerprint data may, for example, include the types, locations and/or spacing of the fingerprint minutiae 205a shown in FIG. 2B and/or the fingerprint minutiae 205b shown in FIG. 2H.

FIG. 2M shows an example of an image corresponding to a master fingerprint. In some implementations, the master fingerprint image 215 may have been obtained during an enrollment process such as that described above. Master fingerprint data corresponding to the master fingerprint image 215 may be stored in memory for authentication processes such as those described herein. The master fingerprint data may, for example, include the types, locations and/or spacing of the fingerprint minutiae 205c and/or the fingerprint minutiae 205d shown in FIG. 2M. In some implementations, the comparing process of block 115 of FIG. 1A may involve comparing such master fingerprint data with partial fingerprint data. For example, if the partial fingerprint data obtained in block 110 corresponds with that shown in FIG. 2B, block 115 may involve comparing the types, locations and/or spacing of fingerprint minutiae 205a with the types, locations and/or spacing of fingerprint minutiae 205c.

However, in some implementations, the master fingerprint image data may be obtained, at least in part, according to alternative processes. In some such implementations, at least some of the master fingerprint image data may be obtained during routine use of a display device. For example, in some implementations, the partial fingerprint data may include known fingerprint data of the current master fingerprint data and new fingerprint data. Such implementations may involve updating the master fingerprint data to include the new fingerprint data. For example, as the fingerprints of youth grow in size and evolve as the fingers grow, the master fingerprint data may also evolve accordingly. For identification purposes such as school lunch programs, the correct authentication of a user throughout a period of growth during a school year without requiring re-enrollment may be a useful convenience.

FIG. 3A is a flow diagram that outlines examples of some methods of updating master fingerprint data. In this example, method 300 begins with block 305, which involves receiving partial fingerprint data. In some implementations, block 305 may be similar to block 110 of FIG. 1A. However, in other implementations, block 305 may involve obtaining partial fingerprint data in other ways, e.g., during routine use of a display device. For example, a fingerprint acquisition system may be positioned under a commonly-used button, icon, etc., of the display device. The fingerprint acquisition system may be capable of obtaining partial fingerprint data on a regular, periodic or other basis.

Here, block 310 involves determining whether the partial fingerprint data includes known fingerprint data and new fingerprint data. If so, the master fingerprint data may be updated to include the new fingerprint data in block 315.

According to some such implementations, the updating process may involve augmenting the master fingerprint data to include the new fingerprint data. For example, referring to FIGS. 2A-2L, suppose the current the master fingerprint data at a particular time were to include fingerprint data corresponding with the fingerprint images 13 shown within the area 210. The master fingerprint data could have been obtained during an enrollment process and/or during multiple iterations of a process such as that of block 110 of FIG. 1A. During some instance of a process such as that of block 110, the partial fingerprint data obtained may include known fingerprint data of the current master fingerprint data and new fingerprint data.

For example, if the partial fingerprint data obtained were to correspond with the fingerprint images 13 shown in FIG. 2C or FIG. 2F, the partial fingerprint data obtained would include known fingerprint data of the current master fingerprint data, corresponding with the fingerprint images 13 shown in FIGS. 2B, 2E and 2H. There could be sufficient overlap between the newly-obtained partial fingerprint data and the previously-known fingerprint data of the current master fingerprint data to determine that the newly-obtained partial fingerprint data was obtained from the rightful user. However, the newly-obtained partial fingerprint data would also include new fingerprint data corresponding with the right portions of the fingerprint images 13 shown in FIG. 2C or FIG. 2F. Some implementations may involve augmenting the master fingerprint data to include the new fingerprint data. Such implementations may involve adding new data to the master fingerprint data regarding the location, spacing and/or types of minutiae. Some relevant methods and devices are disclosed in paragraphs [022]-[0055] and the corresponding figures of U.S. patent application Ser. No. 13/107, 635, entitled “Ultrasonic Area-Array Sensor with Area-Image Merging” and filed on May 13, 2011, which material is hereby incorporated by reference.

Alternatively, or additionally, the updating process may involve adapting the master fingerprint data. As a child grows, for example, his or her digits will become larger and the spacing between minutiae will increase. However the types and relative positions of the minutiae may remain substantially the same. Accordingly, in block 310, the partial fingerprint data may be recognized as those of a rightful user, even though the spacing between minutiae may have increased, e.g., beyond a predetermined threshold. Block 315 may involve updating the master fingerprint data by changing, scaling, or otherwise adapting data corresponding to the spacing between at least some of the minutiae. In this example, the process ends in block 320. However, some implementations involve multiple iterations of the blocks shown in FIG. 3A.

Mobile handheld display devices may be moved, held and touched on in many different ways. Accordingly, various methods described herein can adapt to the many different ways that the same user may interact with his/her device. FIG. 3B provides an example of a user holding a mobile display device in a left hand. In this example, a user is touching an image 130 (which is an icon in this example) with a touching portion of a left thumb 325a. The touching portion is a side portion of the left thumb 325a in this example. Accordingly, the finger touch shown in FIG. 3B involves left-thumb-side touching.

FIG. 3C provides an example of a user holding a mobile display device in a right hand. In this example, a user is touching an image 130 with a touching portion of a right thumb 325b. The touching portion is a side portion of the right thumb 325b in this example. Accordingly, the finger touch shown in FIG. 3C involves right-thumb-side touching.

FIG. 3D provides an example of a user interacting with a mobile display device that is lying on a surface. In this example, a user is touching an image 130 with a touching portion of a right index finger 330. The touching portion is a fingertip portion of the right index finger 330 in this example. Accordingly, the finger touch shown in FIG. 3D involves fingertip touching. In the example shown in FIG. 3D, at least a portion of the fingerprint acquisition system 135 is located outside of the area of the display 1330. In this implementation, a portion of the fingerprint acquisition system 135 that is located outside of the display 1330 corresponds, in part, with the location of a button 370a. FIG. 3E shows another example of a display device that includes a fingerprint acquisition system. In this example, at least a portion of the fingerprint acquisition system 135 is located on the back of the display device. The appearance and/or tactile sensations of the buttons 370a and 370b may facilitate the use of the fingerprint acquisition system 135. For example, such visual and/or tactile cues may make it easier for a user to determine where to place a finger or other digit for acquiring fingerprint data, even if a user is currently viewing a display on the front of the display device 1340.

FIG. 4A is a flow diagram that provides an example of determining whether to authorize a transaction based, at least in part, on a level of security. In this example, method 400 begins with block 405, which involves presenting an image on a display device indicating an area for a user to touch in order to make a commercial transaction. In some implementations, the image may be an icon, such as the “tap to pay” icons shown in FIGS. 1B and 1C.

In this implementation, block 410 involves determining a level of security corresponding to the commercial transaction. Block 410 may, for example, involve determining a level of security based on a transaction amount, which may correspond with a requested payment amount for the commercial transaction and/or an amount of money to be transferred between accounts. In alternative implementations, the level of security determined in block 410 may be based on various other factors, such as a type of merchandise, an amount of available credit and/or the user's credit score.

In this example, block 415 involves obtaining partial fingerprint data from at least a partial finger touch in the area as presented in block 405. The partial fingerprint data may correspond to a touching portion of a finger or a thumb. Here, block 420 involves comparing the partial fingerprint data with master fingerprint data of a rightful user. In this implementation, block 425 involves determining, based at least in part on the comparing process and the level of security, whether to authorize the commercial transaction.

In some implementations, method 400 (and/or other methods described herein) may involve determining that additional data will be required in order to determine whether to authorize the commercial transaction. The additional data may include full fingerprint data for at least one finger, a finger tap characteristic, device movement data, other authentication data, or a combination thereof. Some examples are provided below.

FIG. 4B is a graph that shows an example of determining a level of security based on a transaction amount. In this example, all transactions will require at least obtaining partial fingerprint data, as shown by blocks 455. If the transaction amount is above a threshold 460, both partial fingerprint data and finger tap characteristic data will be evaluated, as shown by blocks 465. If the transaction amount is above a threshold 470, partial fingerprint data, finger tap characteristic data and device movement data will be evaluated, as shown by blocks 475. If the transaction amount is above a threshold 480, partial fingerprint data, finger tap characteristic data, device movement data and full fingerprint data (and/or multiple fingerprint data) will be evaluated, as shown by blocks 485. For example, the user may be prompted to provide full fingerprint data by placing one or more fingers or thumbs flat upon a designated area of a display device.

In alternative implementations, the lowest level of security may correspond to other authentication data, including but not limited to the other types of authentication data shown in FIG. 4B. For example, in some alternative implementations, the lowest level of security may correspond to finger tap characteristic data. Moreover, other types of authentication data may be captured and evaluated as part of a determination as to whether to invoke a function, such as authorizing a transaction. For example, in some implementations, handwriting data may be obtained from a user and used as a type of authentication data. In some implementations, voice data may be obtained from a user (e.g., via a microphone) and used as a type of authentication data.

FIGS. 4C and 4D show examples of device movements that may be captured as device movement data. As shown in FIG. 4C, when a left-handed user is about to start using the display device 1340, the user may generally rotate the display device 1340 in a counterclockwise direction, as shown by the arrow 477a. In this example, a left-handed user has just rotated the display device 1340 around the axis 479. However, in other examples, the display device 1340 may be rotated around another axis, such as an axis that is within an angle range of the axis 479 (e.g., within 30 degrees, within 45 degrees, etc.).

As shown in FIG. 4D, when a right-handed user is about to start using the display device 1340, the user may generally rotate the display device 1340 in a clockwise direction, as shown by the arrow 477b. In this example, a right-handed user has just rotated the display device 1340 around the axis 479, but in other examples the axis of rotation may vary. When a user picks up a phone from a table, the direction and axis of rotation may depend on the handedness of the user and the initial orientation of the phone on the table, whereas pulling out a phone from a purse or pocket may have an opposite rotation. The orientation and angular rate sensors in the phone may provide useful information in detecting a particular user's handling profile.

Each user may have habitual or characteristic ways of moving the display device, including but not limited to the rotation angle, the rotational velocity and/or acceleration associated with the above-described device movement. A user also may have characteristic ways of holding and/or moving the display device when using it, such as characteristic viewing angles, characteristic tapping forces, characteristic tapping directions, etc. For example, some users may tend to use a “landscape” view, others may prefer a “portrait” view and others may switch between such views. Tapping with a left thumb will tend to produce different device movements than tapping with a right thumb or tapping with an index finger. Tapping a display device that is lying on a surface, such as a desktop, will tend to produce different device movements than tapping a display device held in the hand.

The corresponding device movement data may be detected by one or more motion sensors of a motion sensor system, e.g., by one or more gyroscopes and/or accelerometers of a motion sensor system. In some implementations, some device movements (e.g., of the type shown in FIGS. 4C and 4D) may cause a control system to switch on a device, such as a fingerprint acquisition system. In some implementations, the device movement data of a rightful user may be acquired and stored, e.g., during an enrollment process and/or while the display device is in normal use by the rightful user. The rightful user's device movement data may be used as a type of authentication data. In some implementations, a sequence of twists and rates of twist (for example, two counterclockwise snaps of a phone with an intervening relaxation step) may serve as an authorization code that may be combined with other data to authenticate a user or authorize a transaction.

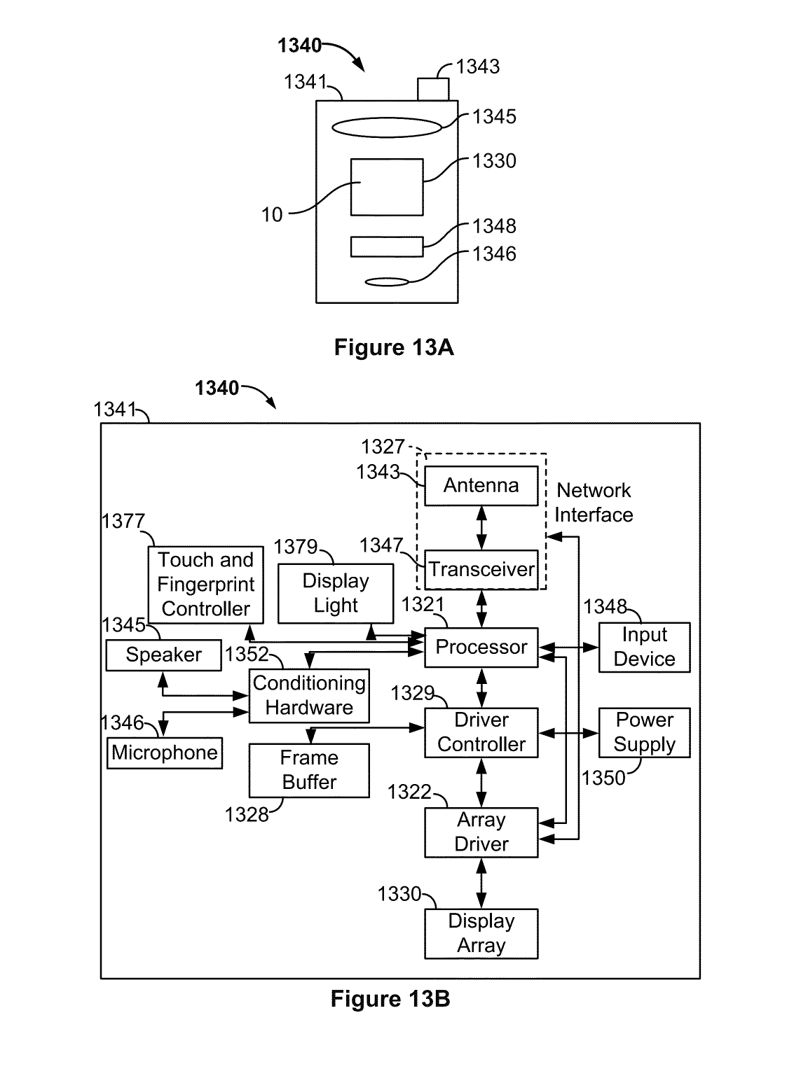

FIG. 5 is a block diagram that shows examples of display device components. In this example, the display device 1340 includes a display 1330, a fingerprint acquisition system 135 and a control system 50. The display 1330 may be any suitable type of display, such as the types of display 1330 described below with reference to FIGS. 13A and 13B.

The control system 50 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system 50 also may include (and/or be configured for communication with) one or more memory devices, such as one or more random access memory (RAM) devices, read-only memory (ROM) devices, etc.

The control system 50 may be capable of controlling the display to present an image indicating an area for a user to touch and of controlling the fingerprint acquisition system to obtain partial fingerprint data from at least a partial finger touch in the area. The partial fingerprint data may correspond to a touching portion of a finger or a thumb. The control system 50 may be capable of comparing the partial fingerprint data with master fingerprint data of a rightful user and determining, based at least in part on the comparing process, whether to invoke a function. Invoking the function may, for example, involve authorizing a transaction, starting a personalized application, or unlocking the display device.

The partial fingerprint data may, in some instances, include known fingerprint data of the current master fingerprint data and new fingerprint data. In some implementations, the control system may be capable of updating the master fingerprint data to include the new fingerprint data. For example, the control system may be capable of augmenting the master fingerprint data and/or adapting the master fingerprint data.

The fingerprint acquisition system 135 may be any suitable fingerprint acquisition system, including but not limited to the examples described herein. In some implementations, the fingerprint acquisition system 135 may include an ultrasonic imaging system. For example, the fingerprint acquisition system 135 may include an ultrasonic sensor array and an ultrasonic transmitter. According to some implementations, the obtaining process may involve obtaining the partial fingerprint data via the ultrasonic sensor array while maintaining the ultrasonic transmitter in an “off” state. In some examples, the fingerprint acquisition system 135 may be positioned within a display area or, at least in part, outside the display area.

In some implementations, the display device 1340 may include a motion sensor system 520. The motion sensor system 520 may be capable of sensing device movement and providing device movement data to the control system. The control system may be capable of determining whether the device movement data corresponds with device movement data of the rightful user. The process of determining whether to invoke the function may be based, at least in part, on whether the device movement data corresponds with device movement data of the rightful user.

In some examples, the display device 1340 may include a finger tap sensing system 530. The finger tap sensing system 530 may include one or more microphones. In some implementations, the finger tap sensing system 530 may include one or more components of the fingerprint acquisition system 135 and/or one or more components of a touch sensing system.

The control system may be capable of receiving, from the finger tap sensing system 530, information regarding one or more finger taps. The control system may be capable of determining finger tap characteristic data based on the finger tap information. For example, the finger tap characteristic data may corresponds with a number of taps, a frequency of taps and/or an auditory signature. The process of determining whether to invoke the function may be based, at least in part, on comparing the finger tap characteristic data with finger tap characteristic data of the rightful user.

Various implementations described herein relate to touch sensing systems that include a pressure and force sensing device capable of sensing dynamic pressure or dynamic force. For the sake of simplicity, such a pressure and force sensing device may be referred to herein simply as a “force-sensing device.” Similarly, an applied pressure and force may be referred to herein simply as an “applied force” or the like, with the understanding that applying force with a physical object will also involve applying pressure. In some implementations, the touch sensing system may include a piezoelectric sensing array. In such implementations, an applied force may be detected (and optionally recorded) during a period of time that the force is applied and changing. In some implementations, the force-sensing device may have a sufficiently high resolution to function as a fingerprint sensor.

In some implementations, the touch sensing system may include one or more additional components capable of fingerprint sensing, such as an ultrasonic transmitter that allows the device to become an ultrasonic transducer capable of imaging a finger in detail. In some such implementations, the force-sensing device also may be capable of functioning as an ultrasonic receiver to detect acoustic or ultrasonic energy such as acoustic emissions from a tap on the surface of the sensing system or ultrasonic waves reflected from the surface.

FIG. 6A is a block diagram of one example of a touch sensing system. FIGS. 6B and 6C are schematic representations of examples of the touch sensing system shown in FIG. 6A, with additional details shown of a single sensor pixel. Referring first to FIG. 6A, in this example the touch sensing system 10 includes a force-sensing device 30 having an array of sensor pixels 32 disposed on a substrate 34, the array of sensor pixels 32 being capable of receiving charges from a piezoelectric film layer 36 via pixel input electrodes 38. In this example, the piezoelectric film layer 36 is also configured for electrical contact with a receiver bias electrode 39. A control system 50 is capable of controlling the force-sensing device 30, e.g., as described below.

In the example shown in FIG. 6B, the substrate 34 is a thin film transistor (TFT) substrate. The array of sensor pixels 32 is disposed on the TFT substrate. Here, each of the sensor pixels 32 has a corresponding pixel input electrode 38, which is configured for electrical connection with a discrete element 37 of the piezoelectric film layer 36. The receiver bias electrode 39, which is connected to an externally applied receiver bias voltage 6 in this example, is disposed on an opposite side of the piezoelectric film layer 36 with respect to the pixel input electrodes 32. In this example, the applied receiver bias voltage 6 is at ground potential. Some implementations may include a continuous receiver bias electrode 39 for each row or column of sensor pixels 32. Alternative implementations may include a continuous receiver bias electrode 39 above all of the sensor pixels 32 in the sensor pixel array.

Force applied by the object 25, which is a finger in this example, may squeeze or otherwise deform at least some of the discrete elements 37 of the piezoelectric layer 36. The receiver bias electrode 39 and the pixel input electrodes 38 allow the array of sensor pixels 32 to measure the electrical charge generated on the surfaces of the discrete elements 37 of the piezoelectric layer 36 that result from the deformation of the discrete elements 37.

FIG. 6B also shows an enlarged view of one example of a single sensor pixel 32a. In this example, the charge produced at each of the pixel input electrodes of each sensor pixel is input to a charge amplifier 7. Amplified charges from the charge amplifier 7 are provided to a peak detection circuit 8 in this example. The peak detection circuit 8 may be capable of registering a maximum amount of charge produced by the force applied to the piezoelectric layer 36, as amplified by the charge amplifier 7. An output signal 12 from the peak detection circuit 8 may be read out at a corresponding output connection. In this implementation, the reset device 9 is capable of discharging the storage capacitor of the peak detection circuit 8, so that the force-sensing device 30 may detect subsequent force or pressure instances. In this example, the charge is held until a corresponding signal is provided to a control system, such as the control system 50 shown in FIG. 6A. Each row or column of sensor pixels 32 may be scanned via a row select mechanism, a gate driver, a shift register, etc. Some examples are described below.

The control system 50 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system 50 also may include (and/or be configured for communication with) one or more memory devices, such as one or more random access memory (RAM) devices, read-only memory (ROM) devices, etc. The control system 50 may be capable of determining a location in which the object 25 is exerting a force on the force-sensing device 30 according to signals provided by multiple sensor pixels 32. In some implementations, the control system 50 may be capable of determining locations and/or movements of multiple objects 25. According to some such implementations, the control system 50 may be capable of controlling a device according to one or more determined locations and/or movements. For example, in some implementations, the control system 50 may be capable of controlling a mobile display device, such as the display device 1340 shown in FIGS. 13A and 13B, according to one or more determined locations and/or movements.

According to some implementations, the force-sensing device 30 may have a sufficiently high resolution for the touch sensing system 10 to function as a fingerprint sensor. In some implementations, some of which are described below, the touch sensing system 10 may include an ultrasonic transmitter and the force-sensing device 30 may be capable of functioning as an ultrasonic receiver. The control system 50 may be capable of controlling the ultrasonic transmitter and/or the force-sensing device 30 to obtain fingerprint image data, e.g., by capturing fingerprint images. Whether or not the touch sensing system 10 includes an ultrasonic transmitter, the control system 50 may be capable of controlling access to one or more devices based, at least in part, on the fingerprint image data.

In some implementations, the control system 50 may be capable of operating the touch sensing system in an ultrasonic imaging mode or a force-sensing mode. In some implementations, the control system may be capable of maintaining the ultrasonic transmitter in an “off” state when operating the touch sensing system in a force-sensing mode.

In this example, the reset device 9 is capable of resetting the peak detection circuit 8 after reading the charge, making the peak detection circuit 8 ready for reading subsequent charges from the charge amplifier 7. In some implementations, addressing and/or resetting functionality may be provided by TFTs of the TFT substrate 34. A readout transistor for each row or column may be triggered to allow the magnitude of the peak charge for each pixel to be read by additional circuitry not shown in FIG. 6B, e.g., a multiplexer and/or an A/D converter.

The elements of the force-sensing device 30 shown in FIGS. 6A and 6B are merely examples. An alternative implementation of a force-sensing device 30 is shown in FIG. 6C. In this example, the charge amplifier 7 is an integrating charge amplifier, which includes a diode and a capacitor. In this implementation, the array of sensor pixels 32 is capable of measuring the charge developed across the piezoelectric layer 36 that results from the discrete elements 37 corresponding to each affected sensor pixel 32 being tapped, squeezed, or otherwise deformed. Here, the charge of each affected sensor pixel 32 is input to the integrating charge amplifier. The charges from the integrating charge amplifier may be processed substantially as described above.

In some implementations, the touch sensing system 10 may include one or more additional components, such as an ultrasonic transmitter that allows the touch sensing system 10 to function as an ultrasonic transducer capable of imaging a finger in detail. In some such implementations, the force-sensing device 30 may be capable of functioning as an ultrasonic receiver.

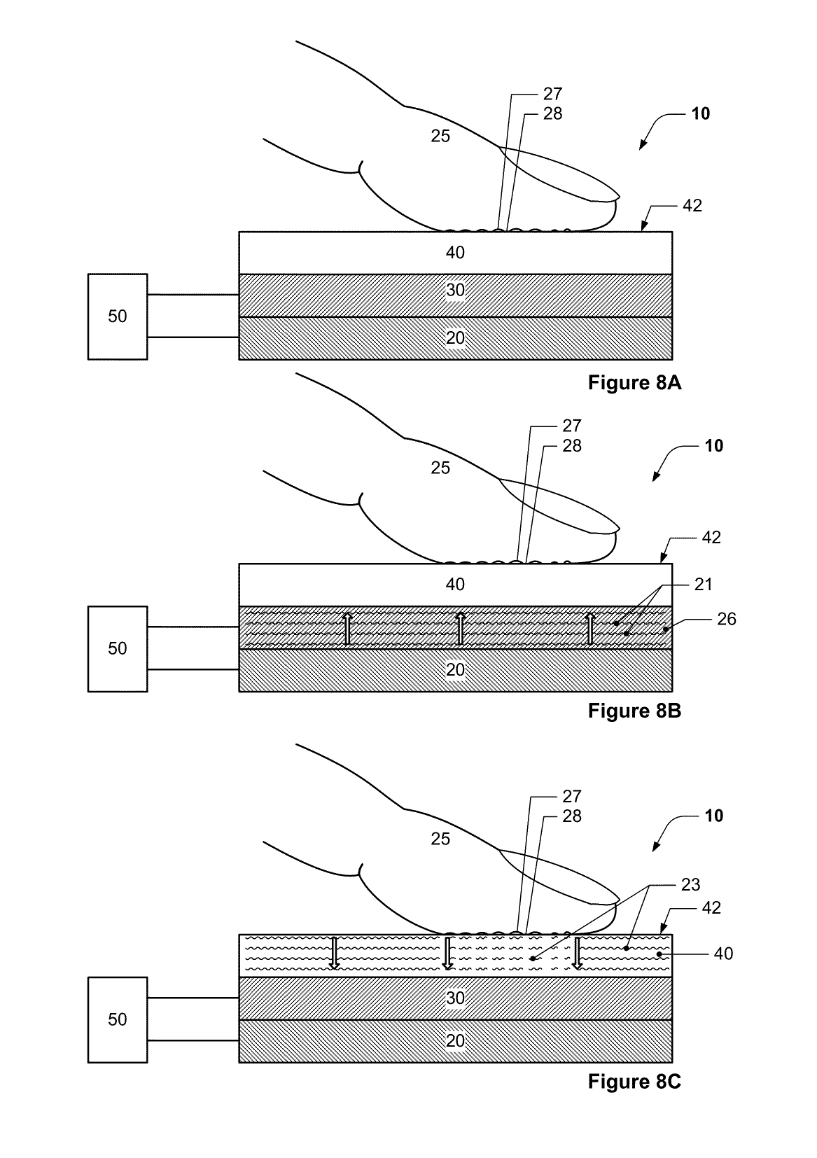

FIG. 7 is a flow diagram that outlines an example of a process of receiving user input from a force-sensing device and turning an ultrasonic transmitter on or off according to the user input. In this example, method 700 begins with block 705, which involves receiving an indication of a user touch or tap from a force-sensing device 30 of a touch sensing system 10. Block 710 involves operating the touch sensing system 10 in an ultrasonic imaging mode based, at least in part, on the touch or tap.

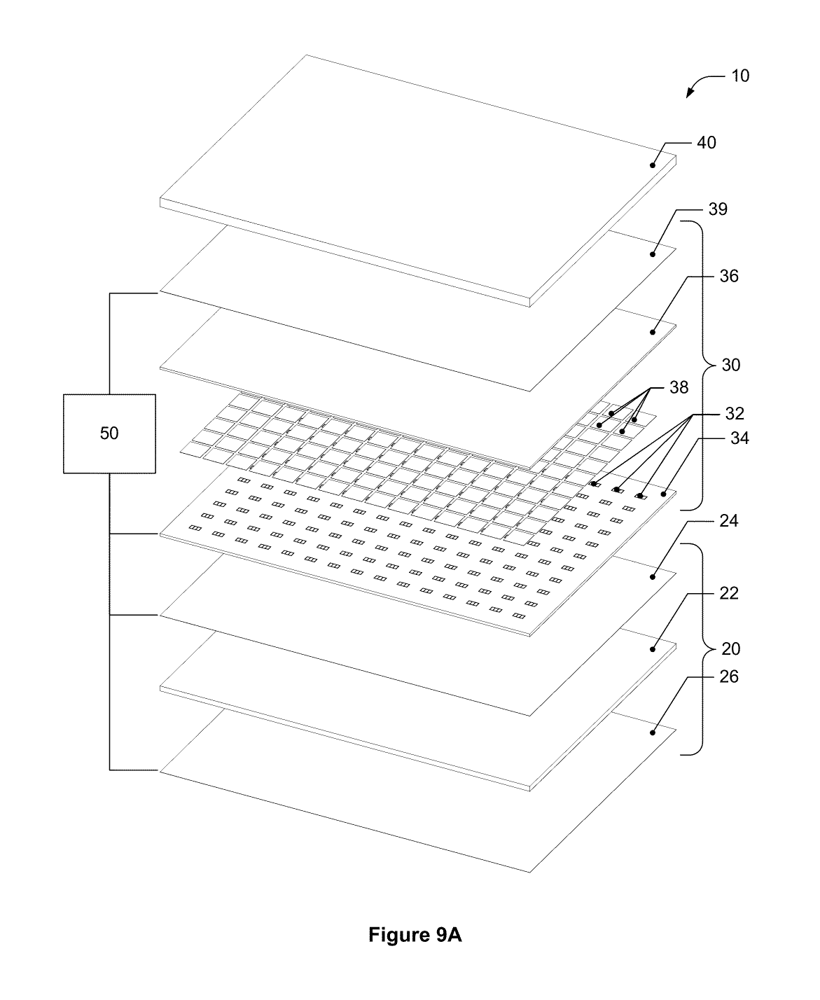

FIGS. 8A-8C provide examples of the process outlined in FIG. 7. As shown in FIG. 8A, touch sensing system 10 includes an ultrasonic transmitter 20 and a force-sensing device 30 under a platen 40. Here, the control system 50 is electrically connected (directly or indirectly) with the ultrasonic transmitter 20 and the force-sensing device 30. In this example, the force-sensing device 30 is capable of functioning as an ultrasonic receiver. Here, the force-sensing device 30 includes a piezoelectric material and an array of sensor pixel circuits disposed on a substrate.

The ultrasonic transmitter 20 may be a piezoelectric transmitter that can generate ultrasonic waves 21 (see FIG. 8B). At the moment depicted in FIG. 8A, however, the ultrasonic transmitter 20 may be switched off or in a low-power “sleep” mode. Upon receiving an indication of a user touch or tap from a force-sensing device 30, the control system 50 may be capable of switching on the ultrasonic transmitter 20.

In the example shown in FIG. 8B, the control system 50 is capable of controlling the ultrasonic transmitter 20 to generate ultrasonic waves. For example, the control system 50 may supply timing signals that cause the ultrasonic transmitter 20 to generate one or more ultrasonic waves 21. In the example shown in FIG. 8B, ultrasonic waves 21 are shown traveling through the force-sensing device 30 to the exposed surface 42 of the platen 40. At the exposed surface 42, the ultrasonic energy corresponding with the ultrasonic waves 21 may either be absorbed or scattered by an object 25 that is in contact with the platen 40, such as the skin of a fingerprint ridge 28, or reflected back.

As shown in FIG. 8C, in those locations where air contacts the exposed surface 42 of the platen 40, e.g., the valleys 27 between the fingerprint ridges 28, most energy of the ultrasonic waves 21 will be reflected back toward the force-sensing device 30 for detection. The control system 50 may then receive signals from the force-sensing device 30 that are indicative of reflected ultrasonic energy 23. The control system 50 may use output signals received from the force-sensing device 30 to determine a location of the object 25 and/or construct a digital image of the object 25. In some implementations, the control system 50 may be configured to process output signals corresponding to multiple objects 25 simultaneously. According to some implementations, the control system 50 may also, over time, successively sample the output signals to detect movement of one or more objects 25.

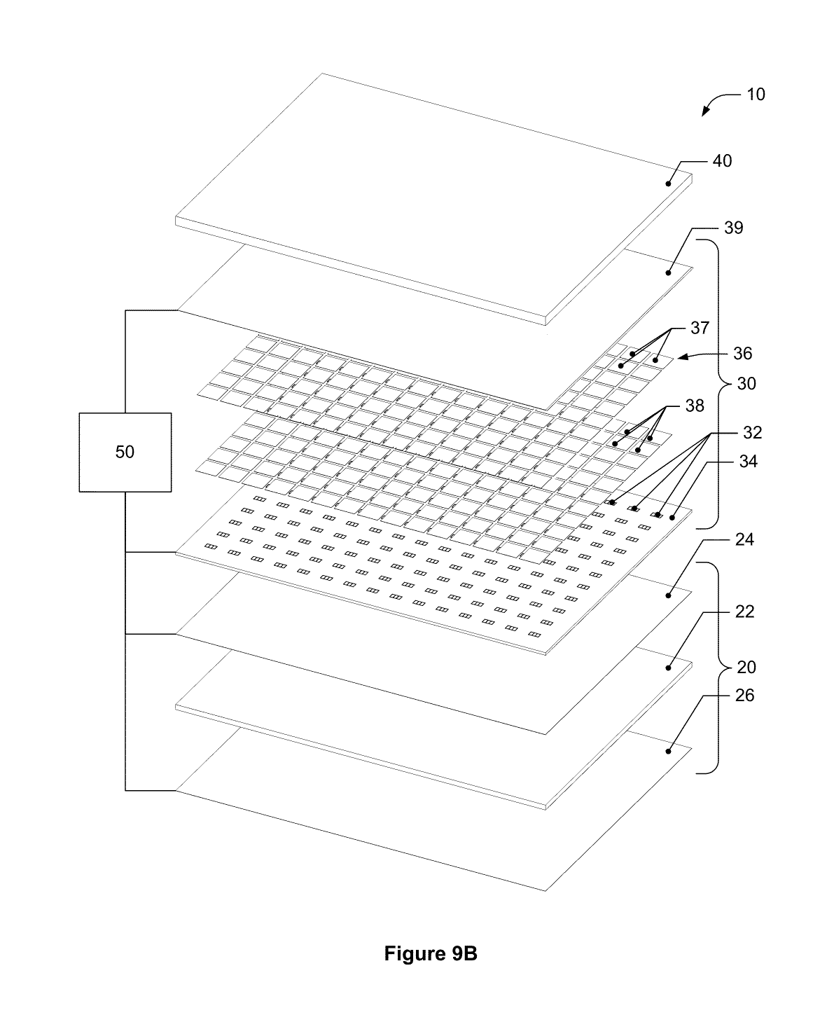

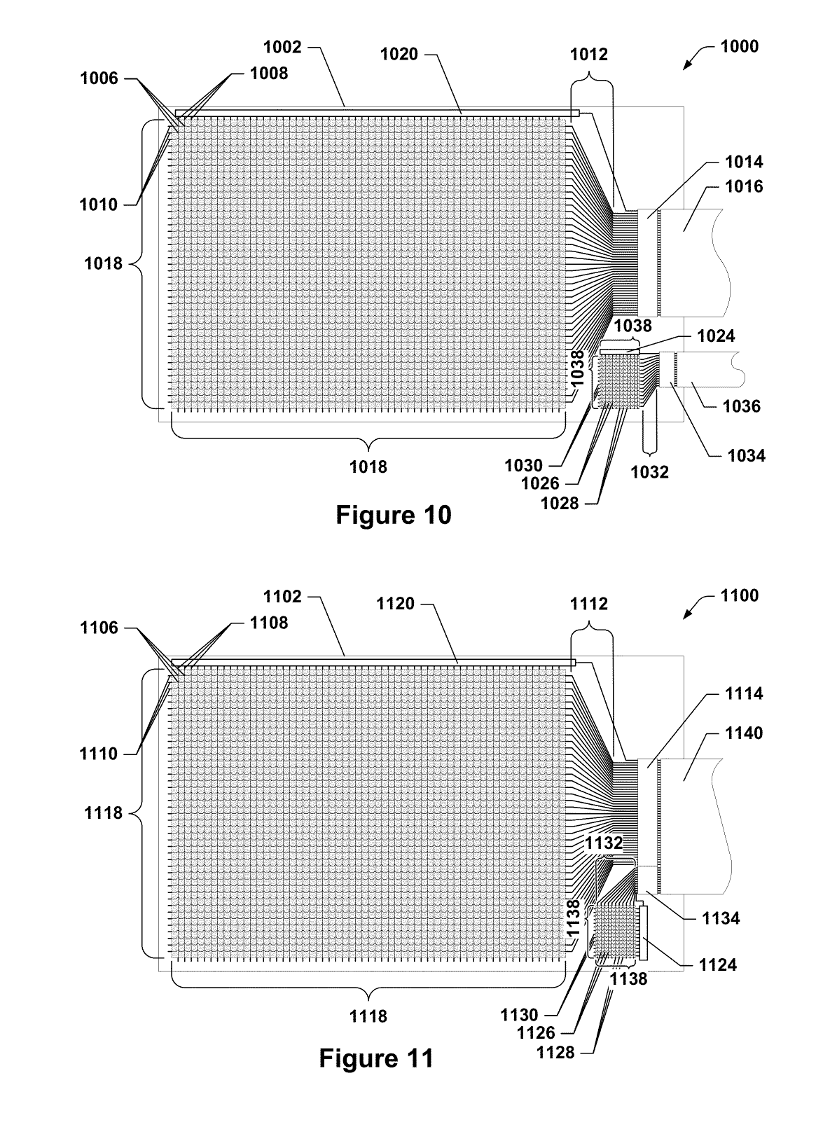

FIG. 9A shows an example of an exploded view of a touch sensing system. In this example, the touch sensing system 10 includes an ultrasonic transmitter 20 and a force-sensing device 30 under a platen 40. The ultrasonic transmitter 20 may include a substantially planar piezoelectric transmitter layer 22 and may be capable of functioning as a plane wave generator. Ultrasonic waves may be generated by applying a voltage to the piezoelectric layer to expand or contract the layer, depending upon the signal applied, thereby generating a plane wave. In this example, the control system 50 may be capable of causing a voltage that may be applied to the piezoelectric transmitter layer 22 via a first transmitter electrode 24 and a second transmitter electrode 26. In this fashion, an ultrasonic wave may be made by changing the thickness of the layer. This ultrasonic wave may travel towards a finger (or other object to be detected), passing through the platen 40. A portion of the wave not absorbed by the object to be detected may be reflected so as to pass back through the platen 40 and be received by the force-sensing device 30. The first and second transmitter electrodes 24 and 26 may be metallized electrodes, for example, metal layers that coat opposing sides of the piezoelectric transmitter layer 22.

The force-sensing device 30 may include an array of sensor pixel circuits 32 disposed on a substrate 34, which also may be referred to as a backplane, and a piezoelectric film layer 36. In some implementations, each sensor pixel circuit 32 may include one or more TFT elements and, in some implementations, one or more additional circuit elements such as diodes, capacitors, and the like. Each sensor pixel circuit 32 may be configured to convert an electric charge generated in the piezoelectric film layer 36 proximate to the pixel circuit into an electrical signal. Each sensor pixel circuit 32 may include a pixel input electrode 38 that electrically couples the piezoelectric film layer 36 to the sensor pixel circuit 32.

In the illustrated implementation, a receiver bias electrode 39 is disposed on a side of the piezoelectric film layer 36 proximal to platen 40. The receiver bias electrode 39 may be a metallized electrode and may be grounded or biased to control which signals may be passed to the array of sensor pixel circuits 32. Ultrasonic energy that is reflected from the exposed (top) surface 42 of the platen 40 may be converted into localized electrical charges by the piezoelectric film layer 36. These localized charges may be collected by the pixel input electrodes 38 and passed on to the underlying sensor pixel circuits 32. The charges may be amplified by the sensor pixel circuits 32 and then provided to the control system 50. Simplified examples of sensor pixel circuits 32 are shown in FIGS. 6B and 6C. However, one of ordinary skill in the art will appreciate that many variations of and modifications to the example sensor pixel circuits 32 may be contemplated.

The control system 50 may be electrically connected (directly or indirectly) with the first transmitter electrode 24 and the second transmitter electrode 26, as well as with the receiver bias electrode 39 and the sensor pixel circuits 32 on the substrate 34. In some implementations, the control system 50 may operate substantially as described above. For example, the control system 50 may be capable of processing the amplified signals received from the sensor pixel circuits 32.

The control system 50 may be capable of controlling the ultrasonic transmitter 20 and/or the force-sensing device 30 to obtain fingerprint image data, e.g., by obtaining fingerprint images. Whether or not the touch sensing system 10 includes an ultrasonic transmitter 20, the control system 50 may be capable of controlling access to one or more devices based, at least in part, on the fingerprint image data. The touch sensing system 10 (or an associated device) may include a memory system that includes one or more memory devices. In some implementations, the control system 50 may include at least a portion of the memory system. The control system 50 may be capable of capturing a fingerprint image and storing fingerprint image data in the memory system. In some implementations, the control system 50 may be capable of capturing a fingerprint image and storing fingerprint image data in the memory system even while maintaining the ultrasonic transmitter 20 in an “off” state.

In some implementations, the control system 50 may be capable of operating the touch sensing system in an ultrasonic imaging mode or a force-sensing mode. In some implementations, the control system may be capable of maintaining the ultrasonic transmitter 20 in an “off” state when operating the touch sensing system in a force-sensing mode. The force-sensing device 30 may be capable of functioning as an ultrasonic receiver when the touch sensing system 10 is operating in the ultrasonic imaging mode.

In some implementations, the control system 50 may be capable of controlling other devices, such as a display system, a communication system, etc. In some implementations, for example, the control system 50 may be capable of powering on one or more components of a device such as the display device 1340, which is described below with reference to FIGS. 13A and 13B. Accordingly, in some implementations the control system 50 also may include one or more components similar to the processor 1321, the array driver 1322 and/or the driver controller 1329 shown in FIG. 13B. In some implementations, the control system 50 may be capable of detecting a touch or tap received via the force-sensing device 30 and activating at least one feature of the mobile display device in response to the touch or tap. The “feature” may be a component, a software application, etc.

The platen 40 can be any appropriate material that can be acoustically coupled to the receiver, with examples including plastic, ceramic, sapphire and glass. In some implementations, the platen 40 can be a cover plate, e.g., a cover glass or a lens glass for a display. Particularly when the ultrasonic transmitter 20 is in use, fingerprint detection and imaging can be performed through relatively thick platens if desired, e.g., 3 mm and above. However, for implementations in which the force-sensing device 30 is capable of imaging fingerprints in a force detection mode, a thinner and relatively more compliant platen 40 may be desirable. According to some such implementations, the platen 40 may include one or more polymers, such as one or more types of parylene, and may be substantially thinner. In some such implementations, the platen 40 may be tens of microns thick or even less than 10 microns thick.

Examples of piezoelectric materials that may be used to form the piezoelectric film layer 36 include piezoelectric polymers having appropriate acoustic properties, for example, an acoustic impedance between about 2.5 MRayls and 5 MRayls. Specific examples of piezoelectric materials that may be employed include ferroelectric polymers such as polyvinylidene fluoride (PVDF) and polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDR-TrFE. Other examples of piezoelectric materials that may be employed include polyvinylidene chloride (PVDC) homopolymers and copolymers, polytetrafluoroethylene (PTFE) homopolymers and copolymers, and diisopropylammonium bromide (DIPAB).

The thickness of each of the piezoelectric transmitter layer 22 and the piezoelectric film layer 36 may be selected so as to be suitable for generating and receiving ultrasonic waves. In one example, a PVDF piezoelectric transmitter layer 22 is approximately 28 μm thick and a PVDF-TrFE receiver layer 36 is approximately 12 μm thick. Example frequencies of the ultrasonic waves may be in the range of 5 MHz to 30 MHz, with wavelengths on the order of a quarter of a millimeter or less.

FIG. 9B shows an exploded view of an alternative example of a touch sensing system. In this example, the piezoelectric film layer 36 has been formed into discrete elements 37. In the implementation shown in FIG. 9B, each of the discrete elements 37 corresponds with a single pixel input electrode 38 and a single sensor pixel circuit 32. However, in alternative implementations of the touch sensing system 10, there is not necessarily a one-to-one correspondence between each of the discrete elements 37, a single pixel input electrode 38 and a single sensor pixel circuit 32. For example, in some implementations there may be multiple pixel input electrodes 38 and sensor pixel circuits 32 for a single discrete element 37.

FIGS. 8A through 9B show example arrangements of ultrasonic transmitters and receivers in a touch sensing system, with other arrangements possible. For example, in some implementations, the ultrasonic transmitter 20 may be above the force-sensing device 30 and therefore closer to the object(s) 25 to be detected. In some implementations, the touch sensing system 10 may include an acoustic delay layer. For example, an acoustic delay layer can be incorporated into the touch sensing system 10 between the ultrasonic transmitter 20 and the force-sensing device 30. An acoustic delay layer can be employed to adjust the ultrasonic pulse timing, and at the same time electrically insulate the force-sensing device 30 from the ultrasonic transmitter 20. The acoustic delay layer may have a substantially uniform thickness, with the material used for the delay layer and/or the thickness of the delay layer selected to provide a desired delay in the time for reflected ultrasonic energy to reach the force-sensing device 30. In doing so, the range of time during which an energy pulse that carries information about the object by virtue of having been reflected by the object may be made to arrive at the force-sensing device 30 during a time range when it is unlikely that energy reflected from other parts of the touch sensing system 10 is arriving at the force-sensing device 30. In some implementations, the substrate 34 and/or the platen 40 may serve as an acoustic delay layer.

FIGS. 10-12 show examples of display devices having an ultrasonic fingerprint sensor positioned outside a display area. FIG. 10 depicts a schematic plan view of a conceptual 43 by 59 pixel display device (2537 pixels total); a display pixel circuit 1006 is associated with, and located in the vicinity of, each pixel and is located on a backplane 1002. In this example, display scan traces 1008 are associated with each column of display pixel circuits 1006, and display data traces 1010 are associated with each row of display pixel circuits 1006. A display driver chip 1014 is located to one side of display pixel array 1018. A display scan select circuit 1020 may be configured for individual control of each display scan trace 1008. The display scan select circuit 1020 may be driven from the display driver chip 1014 or by another source. The display data traces 1010 may be routed through display fanout 1012 so as to accommodate the difference in spacing between the display data traces 1010 and the pinout spacing of the display driver chip 1014. A display flex cable 1016 may be connected with input/output traces of the display driver chip 1014 to allow the display module 1000 to be communicatively connected with other components, e.g., a processor, that may send data to the display module 1000 for output.

Also depicted in FIG. 10 is a smaller array of sensor pixel circuits 1026 in sensor pixel array 1038, which is an ultrasonic fingerprint sensor pixel array in this example. Each sensor pixel circuit 1026 in the sensor pixel array 1038 may be connected to a sensor scan trace 1028 and a sensor data trace 1030. The data traces 1030 may be routed to a sensor driver chip 1034 via a sensor fanout 1032. A sensor scan select circuit 1024 may be configured for individual control of each sensor scan trace 1028. The sensor scan select circuit 1024 may be driven from the sensor driver chip 1034 or by another source. A sensor flex cable 1036 may be connected to the pinouts of the sensor driver chip 1034. Each sensor pixel circuit 1026 may include one or more TFTs and, in some implementations, one or more other circuit elements such as capacitors, diodes, etc. In contrast to the display pixel circuits 1006 that drive the display pixels, which may be configured to supply voltage or current to a liquid crystal element or to an OLED element, the sensing elements 1026 may instead be configured to receive electrical charges produced by a piezoelectric ultrasonic receiver layer overlaying the sensor pixel array 1038.

It is to be understood that the components shown in FIG. 10 are not drawn to scale, and that other implementations may differ significantly from that shown. For example, the pixel resolution of the display shown is relatively small, but the same backplane arrangement may be used with higher-resolution displays, e.g., 1136×640 pixel displays, 1920×1080 pixel displays, etc. In the same manner, the sensor pixel array may be larger than the 11×14 pixel sensor pixel array 1038 shown. For example, the resolution of the sensor pixel array 1038 may produce a pixel density of approximately 500 pixels per inch (ppi), which may be well-suited for fingerprint scanning and sensing purposes.

In the implementation shown in FIG. 10, the display pixel array 1018 and the sensor pixel array 1038 may be, aside from being located on a common backplane 1002, otherwise entirely separate from one another. The display pixel array 1018 communicates with its own display driver chip 1014 and display flex cable 1016, and the sensor pixel array 1038 communicates with its own sensor driver chip 1034 and sensor flex cable 1036.

A more integrated version of the display module 1100 is depicted in FIG. 11. In FIG. 11, the structures shown may be, in large part, identical to those shown in FIG. 10. Elements in FIG. 11 that are numbered with callouts having the same last two digits as similar structures in FIG. 10 are to be understood to be substantially similar to the corresponding structures in FIG. 10. In the interest of avoiding repetition, the reader is referred to the earlier description of such elements with respect to FIG. 10 with regard to FIG. 11.

One notable difference between FIG. 10 and FIG. 11 is that the display driver chip 1114 and the sensor driver chip 1134 are adjacent to one another and are connected to a common touch and ultrasonic flex cable 1140. In some implementations, the functionality of the display driver chip 1114 and the sensor driver chip 1134 may be provided by a single, integrated chip.

The configurations shown in FIGS. 10 and 11 may be implemented in existing TFT backplanes with little difficulty since no change to the display pixel array 1018/1118 is needed. Additionally, the sensor pixel circuits 1026/1126, e.g., the TFTs and other circuit elements that form the sensor pixel circuits 1026/1126, may be formed during the same processes that are used to form the display pixel circuits 1006/1106. TFT backplane manufacturers may be thus spared any redesign of the display pixel array 1018/1118, allowing fingerprint scanning functionality to be added to an area adjacent to the display pixels at a reduced development cost. Moreover, the actual production of a TFT backplane with a sensor pixel array 1038/1138 such as that shown may involve negligible additional cost since the same processes already used to produce the display pixel array 1018/1118 may be leveraged to concurrently produce the sensor pixel array 1038/1138.

FIG. 12 depicts the example of the display module of FIG. 10 with a high-width ultrasonic fingerprint sensor. In FIG. 12, the structures shown may be, in large part, identical to those shown in FIG. 10. Elements in FIG. 12 that are numbered with callouts having the same last two digits as similar structures in FIG. 10 are to be understood to be substantially similar to the corresponding structures in FIG. 10. In the interest of avoiding repetition, the reader is referred to the earlier description of such elements with respect to FIG. 10 with regard to FIG. 12.

As can be seen, the sensor pixel array 1238 in FIG. 12 is considerably larger in width than the sensor pixel array 1038 is in FIG. 10. This may allow multiple fingertips to be placed on the sensor pixel array 1238 simultaneously, allowing for simultaneous fingerprint recognition across multiple fingertips. Moreover, such larger-footprint sensor pixel arrays may also be used to obtain other biometric information, e.g., a palm print (or partial palm print) may be obtained when a person presses the palm of their hand against the cover glass of the display. In the same manner, other biometric data may be obtained when other portions of a human body are pressed against the cover glass, e.g., ear prints, cheek prints, etc. At the same time, a larger sensor pixel array may also allow for additional input functionality. For example, the sensor pixel array may be configured to detect when a stylus is in contact with the cover glass and to track the motion of the stylus. The resulting XY position data for the stylus tip may be used, for example, to obtain the signature of a user, or to receive stylus input for purposes such as text input or menu selections. Depending on the packaging arrangement, the sensor pixel array may be located as shown, i.e., on the same side of the display module 1200 as the display fanout 1212, or may be located on the opposite side of the display module 1200, i.e., on the opposite side of the display pixel array 1218 from the display fanout 1212. In the former case, the sensor pixel array 1238 may have to share backplane real estate with the display fanout 1212. In the latter case, the sensor pixel array 1238 may extend relatively unimpeded across the entire width (vertical height, with respect to the orientation of FIG. 12) of the display module 1200. In implementations where the sensor pixel array 1238 and the display pixel array 1218 do not share a common backplane, then a full-width sensor pixel array 1238 may be implemented that does not interfere with the display fanout 1212 while still being located on the same side of the display pixel array 1218 as the display fanout 1212.

FIGS. 13A and 13B show examples of system block diagrams illustrating a display device that includes a touch sensing system as described herein. The display device 1340 may be, for example, mobile display device such as a smart phone, a cellular or mobile telephone, etc. However, the same components of the display device 1340 or slight variations thereof are also illustrative of various types of display devices such as televisions, computers, tablets, e-readers, hand-held devices and portable media devices.

In this example, the display device 1340 includes a housing 1341, a display 1330, a touch sensing system 10, an antenna 1343, a speaker 1345, an input device 1348 and a microphone 1346. The housing 1341 may be formed from any of a variety of manufacturing processes, including injection molding, and vacuum forming. In addition, the housing 1341 may be made from any of a variety of materials, including, but not limited to: plastic, metal, glass, rubber and ceramic, or a combination thereof. The housing 1341 may include removable portions (not shown) that may be interchanged with other removable portions of different color, or containing different logos, pictures, or symbols.

The display 1330 may be any of a variety of displays, including a flat-panel display, such as plasma, organic light-emitting diode (OLED) or liquid crystal display (LCD), or a non-flat-panel display, such as a cathode ray tube (CRT) or other tube device. In addition, the display 1330 may include an interferometric modulator (IMOD)-based display or a micro-shutter based display.

The components of one example of the display device 1340 are schematically illustrated in FIG. 13B. Here, the display device 1340 includes a housing 1341 and may include additional components at least partially enclosed therein. For example, the display device 1340 includes a network interface 1327 that includes an antenna 1343 which may be coupled to a transceiver 1347. The network interface 1327 may be a source for image data that could be displayed on the display device 1340. Accordingly, the network interface 1327 is one example of an image source module, but the processor 1321 and the input device 1348 also may serve as an image source module. The transceiver 1347 is connected to a processor 1321, which is connected to conditioning hardware 1352. The conditioning hardware 1352 may be capable of conditioning a signal (such as applying a filter or otherwise manipulating a signal). The conditioning hardware 1352 may be connected to a speaker 1345 and a microphone 1346. The processor 1321 also may be connected to an input device 1348 and a driver controller 1329. The driver controller 1329 may be coupled to a frame buffer 1328, and to an array driver 1322, which in turn may be coupled to a display array 1330. One or more elements in the display device 1340, including elements not specifically depicted in FIG. 13B, may be capable of functioning as a memory device and be capable of communicating with the processor 1321 or other components of a control system. In some implementations, a power supply 1350 may provide power to substantially all components in the particular display device 1340 design.

In this example, the display device 1340 also includes a touch and fingerprint controller 1377. The touch and fingerprint controller 1377 may, for example, be a part of a control system 50 such as that described above. Accordingly, in some implementations the touch and fingerprint controller 1377 (and/or other components of the control system 50) may include one or more memory devices. In some implementations, the control system 50 also may include components such as the processor 1321, the array driver 1322 and/or the driver controller 1329 shown in FIG. 13B. The touch and fingerprint controller 1377 may be capable of communicating with the touch sensing system 10, e.g., via routing wires, and may be capable of controlling the touch sensing system 10. The touch and fingerprint controller 1377 may be capable of determining a location and/or movement of one or more objects, such as fingers, on or proximate the touch sensing system 10. In alternative implementations, however, the processor 1321 (or another part of the control system 50) may be capable of providing some or all of this functionality.

The touch and fingerprint controller 1377 (and/or another element of the control system 50) may be capable of providing input for controlling the display device 1340 according to one or more touch locations. In some implementations, the touch and fingerprint controller 1377 may be capable of determining movements of one or more touch locations and of providing input for controlling the display device 1340 according to the movements. Alternatively, or additionally, the touch and fingerprint controller 1377 may be capable of determining locations and/or movements of objects that are proximate the display device 1340. Accordingly, the touch and fingerprint controller 1377 may be capable of detecting finger or stylus movements, hand gestures, etc., even if no contact is made with the display device 40. The touch and fingerprint controller 1377 may be capable of providing input for controlling the display device 40 according to such detected movements and/or gestures.

As described elsewhere herein, the touch and fingerprint controller 1377 (or another element of the control system 50) may be capable of providing one or more fingerprint detection operational modes. Accordingly, in some implementations the touch and fingerprint controller 1377 (or another element of the control system 50) may be capable of producing fingerprint images.

In some implementations, the touch sensing system 10 may include a force-sensing device 30 and/or an ultrasonic transmitter 20 such as described elsewhere herein. According to some such implementations, the touch and fingerprint controller 1377 (or another element of the control system 50) may be capable of receiving input from the force-sensing device 30 and powering on or “waking up” the ultrasonic transmitter 20 and/or another component of the display device 1340.

The network interface 1327 includes the antenna 1343 and the transceiver 1347 so that the display device 1340 may communicate with one or more devices over a network. The network interface 1327 also may have some processing capabilities to relieve, for example, data processing requirements of the processor 1321. The antenna 1343 may transmit and receive signals. In some implementations, the antenna 1343 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 1343 transmits and receives RF signals according to the Bluetooth® standard. In the case of a cellular telephone, the antenna 1343 may be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 1347 may pre-process the signals received from the antenna 1343 so that they may be received by and further manipulated by the processor 1321. The transceiver 1347 also may process signals received from the processor 1321 so that they may be transmitted from the display device 1340 via the antenna 1343.

In some implementations, the transceiver 1347 may be replaced by a receiver. In addition, in some implementations, the network interface 1327 may be replaced by an image source, which may store or generate image data to be sent to the processor 1321. The processor 1321 may control the overall operation of the display device 1340. The processor 1321 receives data, such as compressed image data from the network interface 1327 or an image source, and processes the data into raw image data or into a format that may be readily processed into raw image data. The processor 1321 may send the processed data to the driver controller 1329 or to the frame buffer 1328 for storage. Raw data typically refers to the information that identifies the image characteristics at each location within an image. For example, such image characteristics may include color, saturation and gray-scale level.

The processor 1321 may include a microcontroller, CPU, or logic unit to control operation of the display device 1340. The conditioning hardware 1352 may include amplifiers and filters for transmitting signals to the speaker 1345, and for receiving signals from the microphone 1346. The conditioning hardware 1352 may be discrete components within the display device 1340, or may be incorporated within the processor 1321 or other components.

The driver controller 1329 may take the raw image data generated by the processor 1321 either directly from the processor 1321 or from the frame buffer 1328 and may re-format the raw image data appropriately for high speed transmission to the array driver 1322. In some implementations, the driver controller 1329 may re-format the raw image data into a data flow having a raster-like format, such that it has a time order suitable for scanning across the display array 1330. Then the driver controller 1329 sends the formatted information to the array driver 1322. Although a driver controller 1329, such as an LCD controller, is often associated with the system processor 1321 as a stand-alone Integrated Circuit (IC), such controllers may be implemented in many ways. For example, controllers may be embedded in the processor 1321 as hardware, embedded in the processor 1321 as software, or fully integrated in hardware with the array driver 1322.

The array driver 1322 may receive the formatted information from the driver controller 1329 and may re-format the video data into a parallel set of waveforms that are applied many times per second to the hundreds, and sometimes thousands (or more), of leads coming from the display's x-y matrix of display elements.

In some implementations, the driver controller 1329, the array driver 1322, and the display array 1330 are appropriate for any of the types of displays described herein. For example, the driver controller 1329 may be a conventional display controller or a bi-stable display controller (such as an IMOD display element controller). Additionally, the array driver 1322 may be a conventional driver or a bi-stable display driver. Moreover, the display array 1330 may be a conventional display array or a bi-stable display. In some implementations, the driver controller 1329 may be integrated with the array driver 1322. Such an implementation may be useful in highly integrated systems, for example, mobile phones, portable-electronic devices, watches or small-area displays.

In some implementations, the input device 1348 may be capable of allowing, for example, a user to control the operation of the display device 1340. The input device 1348 may include a keypad, such as a QWERTY keyboard or a telephone keypad, a button, a switch, a rocker, a touch-sensitive screen, a touch-sensitive screen integrated with the display array 1330, or a pressure- or heat-sensitive membrane. The microphone 1346 may be capable of functioning as an input device for the display device 1340. In some implementations, voice commands through the microphone 1346 may be used for controlling operations of the display device 1340.

The power supply 1350 may include a variety of energy storage devices. For example, the power supply 1350 may be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery may be wirelessly chargeable. The power supply 1350 also may be a renewable energy source, a capacitor, or a solar cell, including a plastic solar cell or solar-cell paint. The power supply 1350 also may be capable of receiving power from a wall outlet.

In some implementations, control programmability resides in the driver controller 1329 which may be located in several places in the electronic display system. In some other implementations, control programmability resides in the array driver 1322. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

1. A method of biometric authentication, comprising:
presenting an image on a display device indicating an area for a user to touch;
obtaining partial fingerprint data from at least a partial finger touch in the area, the partial fingerprint data corresponding to a touching portion of a finger or a thumb;
comparing the partial fingerprint data with master fingerprint data of a rightful user; and
determining, based at least in part on the comparing process, whether to invoke a function.

2. The method of claim 1, wherein invoking the function involves authorizing a transaction, starting a personalized application, or unlocking the display device.

3. The method of claim 1, wherein the partial fingerprint data includes known fingerprint data of the current master fingerprint data and new fingerprint data, and wherein the method further involves updating the master fingerprint data to include the new fingerprint data.

4. The method of claim 3, wherein the updating involves at least one of augmenting the master fingerprint data or adapting the master fingerprint data.

5. The method of claim 1, wherein the method further involves determining finger tap characteristic data of the rightful user, and wherein determining whether to invoke the function is based, at least in part, on comparing finger tap characteristic data of a current user with finger tap characteristic data of the rightful user.

6-8. (canceled)

9. The method of claim 1, wherein the method further includes receiving device movement data and wherein the determining process is based, at least in part, on the device movement data.

10. The method of claim 1, wherein the area is within a display area, outside the display area or on a back of the display device.

11. The method of claim 1, wherein the area overlaps at least a portion of a fingerprint acquisition system.

12-13. (canceled)

14. The method of claim 1, wherein the determination of whether to invoke the function involves determining whether to authorize a transaction based on a level of security.

15. The method of claim 1, wherein the method further includes:
presenting one or more purchasing icons on the display device, the purchasing icons corresponding to purchasable items;
moving a representation of one of the purchasing icons onto the indicated area in response to a corresponding dragging movement of the touching portion of the finger or thumb; and
determining whether to authorize a transaction.

16. The method of claim 1, wherein the method further includes:
presenting one or more application icons on the display device, each of the application icons corresponding to a software application;
moving a representation of one of the application icons onto the indicated area in response to a corresponding dragging movement of the touching portion of the finger or thumb; and
determining whether to start the corresponding application.

17-21. (canceled)

22. A non-transitory medium having software stored thereon, the software including instructions for controlling at least one apparatus to:
present an image indicating an area for a user to touch;
obtain partial fingerprint data from at least a partial finger touch in the area, the partial fingerprint data corresponding to a touching portion of a finger or a thumb;
compare the partial fingerprint data with master fingerprint data of a rightful user; and
determine, based at least in part on the comparing process, whether to invoke a function.

23. The non-transitory medium of claim 22, wherein the function involves authorizing a transaction, starting a personalized application, or unlocking the display device.

24-26. (canceled)

27. The non-transitory medium of claim 22, wherein the software includes instructions for controlling at least one apparatus to:
present one or more purchasing icons on the display device, the purchasing icons corresponding to purchasable items;
move a representation of one of the purchasing icons onto the indicated area in response to a corresponding dragging movement of the touching portion of the finger or thumb; and
determine whether to authorize a transaction.

28. The non-transitory medium of claim 22, wherein the software includes instructions for controlling at least one apparatus to:
present one or more application icons on the display device, each of the application icons corresponding to a software application;
move a representation of one of the application icons onto the indicated area in response to a corresponding dragging movement of the touching portion of the finger or thumb; and
determine whether to start the corresponding application.

29. An apparatus, comprising:
a display;
a fingerprint acquisition system; and
a control system capable of:
controlling the display to present an image indicating an area for a user to touch;
controlling the fingerprint acquisition system to obtain partial fingerprint data from at least a partial finger touch in the area, the partial fingerprint data corresponding to a touching portion of a finger or a thumb;
comparing the partial fingerprint data with master fingerprint data of a rightful user; and
determining, based at least in part on the comparing process, whether to invoke a function.

30. The apparatus of claim 29, further comprising a motion sensor system capable of sensing device movement and providing device movement data to the control system, wherein the control system is capable of determining whether the device movement data corresponds with device movement data of the rightful user.

31. The apparatus of claim 29, further comprising a finger tap sensing system, wherein the control system is further capable of:
receiving, from the finger tap sensing system, information regarding one or more finger taps; and
determining a finger tap characteristic data based on the information regarding one or more finger taps, and wherein determining whether to invoke a function is based, at least in part, on comparing the finger tap characteristic data with finger tap characteristic data of the rightful user.

32. The apparatus of claim 31, wherein the finger tap characteristic data corresponds with at least one of a number of taps, a frequency of taps, a sequence of taps, or an auditory signature.

33. The apparatus of claim 29, wherein the fingerprint acquisition system includes an ultrasonic imaging system.

34. The apparatus of claim 33, wherein the ultrasonic imaging system comprises:
an ultrasonic sensor array; and
an ultrasonic transmitter, and wherein the obtaining involves obtaining the partial fingerprint data via the ultrasonic sensor array while maintaining the ultrasonic transmitter in an “off” state.

35. The apparatus of claim 29, wherein the fingerprint acquisition system is positioned within a display area or, at least in part, outside the display area.

36-47. (canceled)

48. A method of biometric authorization, comprising:
presenting one or more icons on a display;
receiving an indication that a user is interacting with at least one of the icons presented;
acquiring biometric information from a digit, during the user interaction with the icon, when the digit is positioned in a fingerprinting sensing area; and
invoking a function based, at least in part, on the acquired biometric information.

49. The method of claim 48, wherein the acquiring involves obtaining partial fingerprint data from the digit.

50. The method of claim 48, wherein receiving the indication that the user is interacting with an icon involves receiving an indication that the digit is touching an area of the display device corresponding to one of the presented icons.

51. The method of claim 50, wherein receiving the indication further involves receiving an indication of a dragging motion of the digit towards an indicated area.

52. The method of claim 51, wherein the indicated area is displayed on the display.

53. The method of claim 51, wherein the indicated area is an edge of the display.

54. The method of claim 48, wherein receiving the indication that the user is interacting with an icon presented involves receiving an indication that the user has tapped on the icon a number of times or within a range of time intervals.

55. The method of claim 48, wherein acquiring the biometric information involves an ultrasonic imaging process.

56. The method of claim 48, wherein the display is on a front side of a display device and wherein the fingerprint sensing area is on a back side of the display device.

57-59. (canceled)

60. An apparatus, comprising:
a display;
a fingerprint acquisition system; and
a control system capable of:
controlling the display to present an image indicating an area for a user to touch;
obtaining, via the fingerprint acquisition system, partial fingerprint data from at least a partial finger touch in the area, the partial fingerprint data corresponding to a touching portion of a finger or a thumb;
comparing the partial fingerprint data with master fingerprint data of a rightful user; and
determining, based at least in part on the comparing process, whether to authorize a transaction, start a personalized application, or unlock the apparatus.

61. The apparatus of claim 60, wherein the apparatus includes a touch sensing system and wherein the control system is capable of:
controlling the display to present one or more purchasing icons on the display, the purchasing icons corresponding to purchasable items;
receiving, via the touch sensing system, an indication of a dragging movement of the touching portion of the finger or thumb;
controlling the display to move a representation of one of the purchasing icons onto the indicated area, in response to the dragging movement of the touching portion of the finger or thumb; and
determining whether to authorize a transaction.

62. The apparatus of claim 60, wherein the apparatus includes a touch sensing system and wherein the control system is capable of:
controlling the display to present one or more application icons on the display device, each of the application icons corresponding to a software application;
receiving, via the touch sensing system, an indication of a dragging movement of the touching portion of the finger or thumb;
moving a representation of one of the application icons onto the indicated area in response to the dragging movement of the touching portion of the finger or thumb; and
determining whether to start an application that corresponds with the representation of one of the application icons.

63-65. (canceled)
